(19) United States
(12) Patent Application Publication
(10) Pub. No.: US 2026/0254539 A1
(43) Pub. Date: Aug. 27, 2026

(54) Miniaturized Quantum Key Distribution (QKD) Circuits

(71) Applicant: MELLANOX TECHNOLOGIES, LTD., Yokneam (IL)

(72) Inventors: Ziv ABELSON, Even Yehuda (IL); Tal Jhonathan GOFMAN, Haifa (IL); Isabelle CESTIER, Haifa (IL); Ran Hasson RUSO, Pardes Hanna-Karkur (IL); Elad MENTOVICH, Tel Aviv (IL); Paraskevas BAKOPOULOS, Ilion (GR); Dimitrios SYRIVELIS, Volos (GR)

(21) Appl. No.: 19/076,849

(22) Filed: Mar. 11, 2025

(30) Foreign Application Priority Data
Feb. 27, 2025 (GR) 20250100154

(51) Int. Cl. H04B 10/70; H04B 10/25

(52) U.S. Cl. CPC H04B 10/70; H04B 10/2589

(57) ABSTRACT

Apparatuses, systems, computing devices, switches, network endpoints, and methods to enable quantum key distribution (QKD). Systems include a QKD circuit to encode one or more photons according to respective quantum states and a quantum transmitter circuit to enable the encoded photons to transmit via an optical communication channel.

### TECHNICAL FIELD

At least one embodiment is generally directed toward quantum key distribution (QKD) and, in particular, toward a miniaturized QKD circuit and methods of operating the same.

### BACKGROUND

Data centers play a pivotal role in storing, managing, and transmitting vast amounts of data critical to modern communication and computational infrastructure. As the demand for secure data transmission grows, QKD has emerged as a promising technology to enhance security by leveraging principles of quantum mechanics. QKD enables the generation and exchange of cryptographic keys that are inherently secure against eavesdropping, ensuring robust protection for sensitive information. Integrating QKD into data center operations may support secure communication across distributed systems and strengthen data center resilience against emerging cybersecurity threats.

### BRIEF DESCRIPTION OF THE SEVERAL VIEWS OF THE DRAWINGS

The present disclosure is described in conjunction with the appended figures, which are not necessarily drawn to scale:

FIG. 1 illustrates an apparatus in accordance with at least one embodiment;

FIG. 2 illustrates a network of computing systems and nodes in accordance with at least some embodiments of the present disclosure;

FIG. 3 illustrates a transceiver in accordance with at least some embodiments of the present disclosure;

FIG. 4 illustrates a transceiver in accordance with at least some embodiments of the present disclosure;

FIG. 5 is a block diagram of transmitting and receiving components in accordance with at least some embodiments of the present disclosure;

FIG. 6 is a block diagram of transmitting and receiving components in accordance with at least some embodiments of the present disclosure;

FIG. 7 is a block diagram of transmitting components in accordance with at least some embodiments of the present disclosure;

FIG. 8 is a block diagram of transmitting components in accordance with at least some embodiments of the present disclosure;

FIG. 9 illustrates an example data center, in accordance with at least one embodiment;

FIG. 10 illustrates a processing system, in accordance with at least one embodiment;

FIG. 11 illustrates a computer system, in accordance with at least one embodiment;

FIG. 12 illustrates a transceiver, in accordance with at least one embodiment;

FIG. 13 illustrates an example bi-directional quantum interconnect with two (2) communication modules in accordance with one or more embodiments of the present disclosure;

FIG. 14 illustrates a system that facilitates QKD connectivity, in accordance with at least one embodiment;

FIG. 15 illustrates a system that facilitates QKD communication, in accordance with at least one embodiment;

FIG. 16 illustrates a computer system in accordance with at least one embodiment;

FIG. 17 illustrates a system including a NIC for facilitating communication within a network in accordance with at least one embodiment;

FIG. 18A illustrates a transceiver in accordance with at least one embodiment;

FIG. 18B illustrates a transceiver in accordance with at least one embodiment;

FIG. 19 illustrates optical transceiver scenarios in accordance with at least one embodiment;

FIG. 20 illustrates a computing system in accordance with at least one embodiment;

FIG. 21 illustrates a computing environment in accordance with at least one embodiment; and

FIG. 22 illustrates a computing system in accordance with at least one embodiment.

### DETAILED DESCRIPTION

As organizations increasingly rely on interconnected systems for communication, means of securing the transmission and storage of data from cyber threats, ranging from sophisticated hacking techniques to large-scale data breaches, are essential to protecting against unauthorized access, modification, or destruction of data, ensuring confidentiality, integrity, and availability. QKD provides an approach to securing communication channels, leveraging the principles of quantum mechanics to address limitations of traditional cryptographic methods. Unlike classical key exchange mechanisms, QKD enables the creation and exchange of cryptographic keys using quantum properties. QKD provides protection against potential quantum-based attacks. However, conventional QKD technology is expensive both in terms of money and energy and requires a large form factor.

Within data centers, which process, store, and transmit data, the need for advanced cybersecurity measures is critical. Data centers provide essential services ranging from cloud computing to financial transactions and healthcare operations, making the data stored within data centers attractive targets for cyberattacks. The volume and value of sensitive information handled in data centers necessitates robust security protocols to prevent breaches that could compromise data integrity or disrupt operations. Integrating QKD-based cyber security into data center environments provides a defense against potential threats. The systems and methods described herein may be used to fortify data centers with advanced cyber security, enabling an organization to ensure the resilience and reliability of its most critical digital assets.

Commercial QKD systems are typically used for long-haul networks, such as military bases or banking sites, covering distances of tens to hundreds of kilometers. These systems are adapted for long-haul applications and require larger, higher-performance setups. The proposed QKD transceiver is designed for short-range links within data centers, covering distances up to two kilometers providing a way of connecting very quickly and efficiently between the processing systems of the datacenter. This approach allows for a leaner system with reduced requirements, making it smaller, cheaper, and more efficient.

A QKD transceiver as described herein aims to secure specific sections or branches within a data center, focusing on node-to-node links rather than site-to-site links. A QKD transceiver as described herein may provide a QKD link by connecting to a switch, a network interface controller (NIC), or other computing device. This modular approach allows for selective protection of critical nodes within the data center. By focusing on short-range links, the system can be downscaled in size and cost. The goal is to make the QKD transceiver small and affordable enough to be integrated into data center architectures without significant financial or spatial constraints.

In an aspect, QKD technology is based on dedicated optical hardware that alleviates processing requirements imposed, for example, by post-quantum algorithms. QKD technology generally employs specialized optical components and/or dedicated optical paths. The systems and methods described herein provide QKD technology in a miniaturized form factor. Conventional QKD systems are approximately of the order of one rack unit (U) in size. For example, conventional QKD systems consume one U of a 19-inch wide rack. A standard rack in a data center is around 42 U in height. The space requirement for a conventional QKD system is a limitation which greatly decreases the usefulness of the system. Moreover, conventional QKD systems also require power supplies, cooling fans, and other components, increasing the size and cost of incorporating QKD into a data center.

Embodiments include a mini-QKD transceiver which may be used to provide QKD links (QKD interconnects) between devices within a data center as well as in other applications. The transceiver is configured specifically to the intra-datacenter use case ensuring maximum engineering flexibility in regard to miniaturization. Systems and methods described herein provide smaller, less-expensive, and more energy efficient QKD cyber security measures, modules, systems, and/or components, enabling new possibilities for architectures, such as point-to-multipoint solutions not possible with conventional QKD systems. As an example, a QKD transceiver as described herein may be the size of a conventional small form-factor pluggable (SFP) transceiver. Furthermore, a QKD transceiver as described herein may be powered by a device such as a switch or a server with which the transceiver is connected and may require no additional hardware such as other power supplies, cooling fans, or other components.

The QKD transceiver provides a miniaturized QKD transmitter and receiver which can be embedded in a transceiver to form a QKD transceiver to add security to the classical data channels. In a specific case the QKD chiplet/sub-system will be driven by the same ICs as the ones used for the classical channels of the transceiver. The pluggable QKD capable transceiver enables the easy integration of a QKD link wherever needed. The QKD transceiver provides the modularity to provide a full-scale datacenter QKD solution and enables a QKD link capable of being used throughout a data center at the security level or the physical level, from site-to-site, floor-to-floor, or rack-to-rack connections. Implementations include a dedicated board, such as a network adaptor that allows a high level of compatibility to existing hardware, a dedicated pluggable module which provides the QKD capability (pluggable TX, Pluggable RX), a bi-directional pluggable transceiver introducing full TX\RX capabilities, and integrating a QDK transceiver into a standard communication transceiver in either a one sided or bi-directional configuration. Power consumption will be reduced greatly due to short reach of the datacenter link and the lower key rate requirements. Which in turn will reduce the cooling demand. In addition, the transceiver is designed for the datacenter operating temperatures and for integration with other Nvidia products. The transceiver is designed for coexistence in a datacenter infrastructure. In addition, the implementation of TX-RX capabilities provides the flexibility that is required to comfortably employ the transceiver in a wider range of scenarios, such as a via an optical switch, enabling a point-to-multipoint solution which is much sought after in QKD applications.

Need for thermal stability, coexistence of QKD and classical communication, and offloading some QKD elements to NVIDIA's adapter cards to provide an efficient end-to-end solution. Importance of maintaining thermal stability within the miniaturized QKD transceiver. Traditional QKD setups would fail in a transceiver form factor due to massive thermal fluctuations, necessitating solutions for temperature stability, the new system would have different cooling elements compared to rack-sized QKD systems due to the smaller form factor and different thermal dissipation. The miniaturized QKD transceiver would have different cooling requirements compared to rack-sized QKD systems. The smaller form factor and different thermal dissipation characteristics necessitate customized cooling solutions, the thermal dissipation in the miniaturized QKD transceiver is less significant than in larger systems. This allows for the use of standard cooling methods, such as air cooling, for the transceiver optics, while more advanced cooling, like liquid cooling, may be used for QKD components. Maintaining temperature stability is crucial for the miniaturized QKD transceiver. The system must handle temperature fluctuations effectively to ensure reliable operation, which is a key consideration in its design.

The miniaturized QKD transceiver must support the coexistence of QKD and classical communication within the same fiber. This involves using different wavelengths for QKD and classical data transmission, ensuring both can operate simultaneously without interference. To achieve coexistence, different wavelength ranges are used for classical data transmission and QKD signals. This separation ensures that the low-light QKD signals do not interfere with the higher-intensity data signals.

To fit within the transceiver form factor, some QKD elements, such as real-time processing, may be offloaded to NVIDIA's adapter cards. This approach leverages existing infrastructure to handle computationally intensive tasks, reducing the load on the transceiver itself. some processing functions, such as registering bits and running error correction algorithms, would be offloaded to the NIC processor to reduce the load on the transceiver. The QKD system requires processing functions such as registering bits, running error correction algorithms, and performing privacy amplification. These tasks ensure the integrity and security of the shared encryption key. To reduce the load on the transceiver, some processing functions will be offloaded to the NIC processor. This approach leverages the existing computational power of the NIC to handle tasks that require significant processing capabilities. Real-time processing is more demanding and may require offloading to the NIC. This ensures that the QKD system can operate efficiently without overburdening the transceiver.

Thus, to address these and/or other issues, a quantum key distribution enabled intra-datacenter network is disclosed herein. For instance, the system architecture disclosed herein provides deployment of QKD technology in a datacenter network. As such, by employing the QKD technology, datacenter connections can be provided with technological benefits such as, for example, improved security (e.g., to provide information-theoretic security for a datacenter network, etc.), improved performance, improved efficiency, reduced processing load for a host system, and/or one or more other technological benefits. According to one or more embodiments, the system architecture disclosed herein provides deployment of QKD links inside a datacenter network. For instance, according to one or more embodiments, the system architecture disclosed herein can employ one or more QKD-enabled switches and/or one or more QKD links inside a datacenter network. In an embodiment, a QKD link can facilitate transferring one or more keys via quantum communication.

According to various embodiments, a QKD-enabled switch can interface with QKD electro-optical hardware configured to facilitate separation of classical data channels (e.g., classical data channels attached to one or more other ports of the QKD-enabled switch) from quantum data channels (e.g., quantum data channels attached to one or more dedicated hardware such as an encrypting device or a custom network interface controller). According to one or more embodiments, a QKD-enabled switch (e.g., a source QKD-enabled switch) can receive one or more key exchange requests from one or more servers to facilitate establishing secure communication with one or more other servers communicatively coupled to one or more other network switches. In an embodiment where a QKD-enabled switch includes encryption capabilities, the QKD-enabled switch can additionally employ one or more keys for switch-to-switch encryption. Furthermore, according to one or more embodiments, each source QKD-enabled switch can exchange one or more keys with the one or more destination QKD-enabled switches. According to one or more embodiments, a QKD-enabled switch can transmit one or more private keys to the servers. Additionally or alternatively, according to one or more embodiments, a QKD-enabled switch can employ one or more private keys for encrypting specific flows of data.

According to one or more embodiments, hardware and/or intelligence to facilitate QKD technology can be implemented on a QKD-enabled switch. For example, according to one or more embodiments, hardware and/or intelligence to facilitate QKD technology can be implemented on one or more ports of a QKD-enabled switch. Alternatively, according to one or more embodiments, hardware and/or intelligence to facilitate QKD technology can be implemented on a QKD device that is communicatively coupled to a legacy network switch via a QKD link. For example, according to one or more embodiments, a QKD device can be communicatively coupled to a data path port of a legacy network switch, a management port of a legacy network switch, or another port of a legacy network switch via a QKD link. Moreover, as compared to conventional key exchange protocols, embodiments disclosed herein provide for improved security for a datacenter network, improved performance for a datacenter network, and/or improved efficiency for a datacenter network.

For example, a quantum communication channel may refer to a line (e.g., an optical fiber, a quantum line, trace, wire, cable, and/or free space) over which quantum data or information and particles, such as qubits, are exchanged using one or more quantum cryptographic techniques that rely on these quantum properties. Cables (such as the optical cables described below) and connectors as described herein may be designed to comply with any applicable standard, for example Ethernet and InfiniBand standards, such as Ethernet variants 200GBASE-FR4, 400GBASE-FR4, and 100GBASE-LR4 to support four wavelengths.

In at least one embodiment, the techniques described herein are practiced in an active cable being QKD enabled. An active cable may sometimes be referred to as a smart cable, intelligent cable, or using other similar nomenclature. An active cable may include circuitry to perform functions such as signal processing, conversion between transmission formats, conversion between transmission media (such as between electrical and optical transmission media), and so forth. In at least one embodiment, an active cable comprises circuitry for collecting telemetry data and analyzing the data using a machine learning model as described herein. The active cable may further comprise one or more general-purpose or specialized processors for using a machine learning model to obtain an inference of a network traffic pattern and respond to the inference.

Example aspects of the present disclosure provide an apparatus including a QKD circuit, the QKD circuit configured to encode one or more photons according to respective quantum states, and a quantum transmitter circuit, the quantum transmitter circuit configured to enable the encoded one or more photons to transmit via an optical communication channel.

Aspects include wherein the apparatus includes different packaging options, such as wherein the apparatus is one of a mid-board optical module (MBOM), a linear pluggable optics (LPO) transceiver, a quad small form-factor pluggable (QSFP) transceiver, a quad small form-factor pluggable double density (QSFP-DD) transceiver, and co-packaged optics. These options involve integrating the QKD components closer to the switch or within the chassis, providing flexibility in implementation. The pluggable transceivers can be easily integrated into existing data center infrastructure, providing a modular and scalable solution for quantum-secure communication.

Aspects include wherein the apparatus comprises a bi-directional transceiver.

Aspects include wherein the quantum transmitter circuit is further to transmit a data signal via the optical communication channel.

Aspects include wherein the QKD circuit receives power from a device connected to the apparatus.

Aspects include wherein the QKD circuit is further to detect a second one or more photons received by the apparatus and to process a signal from the second one or more photons.

Aspects include wherein the QKD circuit further includes a QKD receiver circuit to detect a transmission comprised of a second one or more photons per symbol.

Aspects include wherein the quantum transmitter circuit comprises an attenuator.

Aspects include a pluggable body, wherein the QKD circuit and the quantum transmitter circuit are within the pluggable body.

Aspects include a data transmitter circuit, a quantum receiver circuit, and a data receiver circuit.

Aspects include a hybrid QKD-data transmitter circuit including the QKD circuit, the quantum transmitter circuit, a data transmitter circuit configured to output a data signal, and a multiplexer configured to multiplex the one or more photons from the quantum transmitter circuit with the data signal from the data transmitter circuit and to output a multiplexed signal via the optical communication channel.

Aspects include a hybrid QKD-data receiver circuit including a second QKD circuit configured to detect qubits received by the apparatus via a second optical communication channel, a data receiver circuit configured to receive a second data signal via the second optical communication channel, and a demultiplexer configured to demultiplex the qubits and the second data signal from a multiplexed optical signal received by the apparatus via the second optical communication channel.

Aspects include wherein the apparatus is an optical switch.

Aspects include wherein the QKD circuit and the quantum transmitter circuit are contained within a co-packaged optics (CPO) package.

Aspects include wherein the apparatus further comprises optical and electronic components integrated in a microchip.

Aspects include wherein the optical communication channel comprises a dedicated fiber link or an existing fiber link can be utilized for coexistence.

In another illustrative example, a transceiver includes a QKD circuit, the QKD circuit to encode one or more photons according to respective quantum states, and a quantum transceiver circuit, the quantum transceiver circuit configured to enable the encoded one or more photons to transmit via an optical communication channel.

Aspects include wherein the transceiver is one of a mid-board optical module (MBOM), a linear pluggable optics (LPO) transceiver, a quad small form-factor pluggable (QSFP) transceiver, and a quad small form-factor pluggable double density (QSFP-DD) transceiver.

Aspects include wherein the transceiver comprises a bi-directional transceiver.

Aspects include wherein the quantum transceiver circuit is further configured to transmit a data signal via the second optical communication channel.

Aspects include wherein the QKD circuit is configured to receive power from a device connected to the transceiver.

Aspects include wherein the QKD circuit is further configured to detect a second one or more photons received by the transceiver and to process a signal from the second one or more photons.

Aspects include wherein the quantum transceiver circuit comprises an attenuator.

Aspects include a data transmitter circuit, a quantum receiver circuit, and a data receiver circuit.

Aspects include a hybrid QKD-data transmitter circuit including the QKD circuit, the quantum transceiver circuit, a data transmitter circuit configured to output a data signal, and a multiplexer configured to multiplex the one or more photons from the quantum transceiver circuit with the data signal from the data transmitter circuit and to output a multiplexed signal via the optical communication channel, and a hybrid QKD-data receiver circuit including a second QKD circuit configured to detect qubits received by the transceiver via a second optical communication channel, a data receiver circuit configured to receive a second data signal via the second optical communication channel, and a demultiplexer configured to demultiplex the qubits and the second data signal from a multiplexed optical signal received by the transceiver via the second optical communication channel.

In another illustrative example, a QKD device includes a QKD circuit, the QKD circuit configured to encode one or more photons according to respective quantum states, and a quantum transceiver circuit, the quantum transceiver circuit configured to transmit the one or more photons via an optical communication channel.

In another illustrative example, a data center includes a plurality of nodes, an optical communication channel providing data communication between the plurality of nodes, and a transceiver. The transceiver includes a QKD circuit, the QKD circuit to encode one or more photons according to respective quantum states, and a quantum transceiver circuit, the quantum transceiver circuit configured to enable the encoded one or more photons to be transmitted between the plurality of nodes via the optical communication channel.

One aspect of the present disclosure is to provide a level of integration of QKD functionality in co-packaged datacenter switches or similar networking devices. Several different architectures are proposed, enabling different partitioning of functionalities.

Co-packaging may refer to the close integration of different electrical and/or optoelectronic chips in the same package. The different chips that constitute the co-packaged system are assembled on a single substrate in what is typically called a multi-chip module (MCM) assembly. The MCM assembly can include switching circuitry surrounded by peripheral chips, which may also be referred to as satellite chips or chiplets. In some embodiments, the switching circuitry and chiplets are all mounted on a common substrate, although such a configuration is not required. The MCM assembly may be provided in a larger housing of the networking device, positioned behind the front panel and transceiver ports exposed at the front panel. The switching circuitry may include one or more core digital Application Specific Integrated Circuits (ASICs), CPUs, GPUs, microprocessors, FPGAs, combinations thereof, and the like.

In the context of high-throughput switches and optoelectronics, co-packaging allows transferring the optoelectronic transceivers from the front panel (where they are currently deployed in the form of pluggable modules) to the MCM chiplets inside the enclosure of the networking device. The fiber optical I/Os from the chiplets are transferred to the front panel where compact optical connectors now reside, replacing the bulky pluggable ports. This saves front panel area which can be used to accommodate integration of a QKD system.

In an illustrative embodiment, a switch includes an MCM assembly, where the MCM assembly includes: switching circuitry; an encryption unit that is configured to encrypt and/or decrypt communications processed by the switching circuitry; and a controller coupled with the MCM assembly and configured to provide interconnectivity between the MCM assembly and a QKD device.

Thus, to address these and/or other issues, a network interface controller for quantum computing over classical and quantum communication channels is disclosed herein. For instance, the system architecture disclosed herein facilitates deployment of QKD technology in a datacenter network. As such, by employing the QKD technology, datacenter connections can be provided with technological benefits such as, for example, improved security (e.g., to provide information-theoretic security for a datacenter network, etc.), improved performance, improved efficiency, reduced processing load for a datacenter system, and/or one or more other technological benefits. In one or more embodiments, an embedded processor within a network interface controller is employed to perform quantum processing (e.g., processing of one or more quantum algorithms). The embedded processor can be, for example, a system on chip (SoC), an FPGA, a GPU, a CPU, or another type of processor. In one or more embodiments, quantum processing includes converting qubits received via a quantum communication link into binary bits. Therefore, instead of employing a dedicated ASIC (e.g., a DSP processor of a coherent processor) to conduct quantum processing, a network interface controller can employ an embedded processor within the network interface controller to conduct quantum processing. Furthermore, by employing an embedded processor within a network interface controller to conduct quantum processing, an interface between QKD-based communications and non-QKD-based communications can be provided. Accordingly, improved utilization of QKD-based communication within datacenters and/or HPC clusters can be provided. For example, in certain implementations a quantum computer can operate within a quantum framework and can also access external resources (e.g., memory blocks) configured for binary-based communications. Moreover, as compared to conventional datacenter networks, embodiments disclosed herein provide for improved security for a datacenter network, improved performance for a datacenter network, and/or improved efficiency for a datacenter network.

The present description provides embodiments only, and is not intended to limit the scope, applicability, or configuration of the claims. Rather, the description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

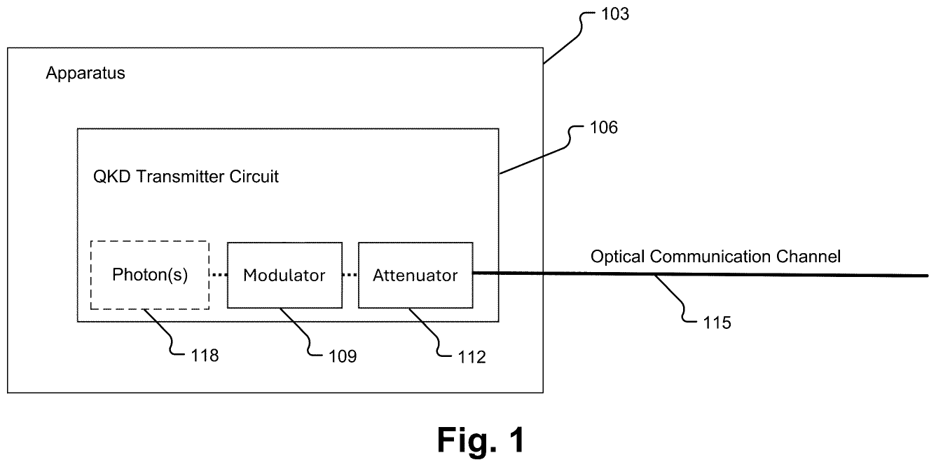

Referring now to FIGS. 1-22, various systems and methods for a QKD transceiver will be described. As illustrated in FIG. 1, in at least one implementation, an apparatus 103 may be a transceiver, such as a pluggable transceiver, as described herein, or may be an optical switch, a NIC, or any type of device capable of sending data. The apparatus 103, according to the implementation, includes a QKD transmitter circuit 106. The QKD transmitter circuit 106 as described herein, may be configured to output optical signals via an optical communication channel 115. The optical communication channel 115 may be an optical link as described herein or any type of medium capable of carrying an optical signal. The QKD transmitter circuit 106, according to the implementation, includes a modulator 109 and an attenuator 112.

The modulator 109 is, according to the implementation, configured to encode one or more photons 118 according to respective quantum states. As described herein, a modulator 109 may be configured to encode or imprint quantum states onto photons 118. The one or more photons 118 may, as described herein, be supplied to the modulator 109 via a light source which may be a part of the QKD transmitter circuit 106, the apparatus 103, or another device. For example, the light source may be external to the apparatus 103.

The attenuator 112 is, according to the implementation, configured to enable the encoded one or more photons to transmit via the optical communication channel 115. As described herein, the attenuator 112 may control the intensity of modulated photons 118 to reduce the intensity to quantum levels when output onto the optical communication channel 115.

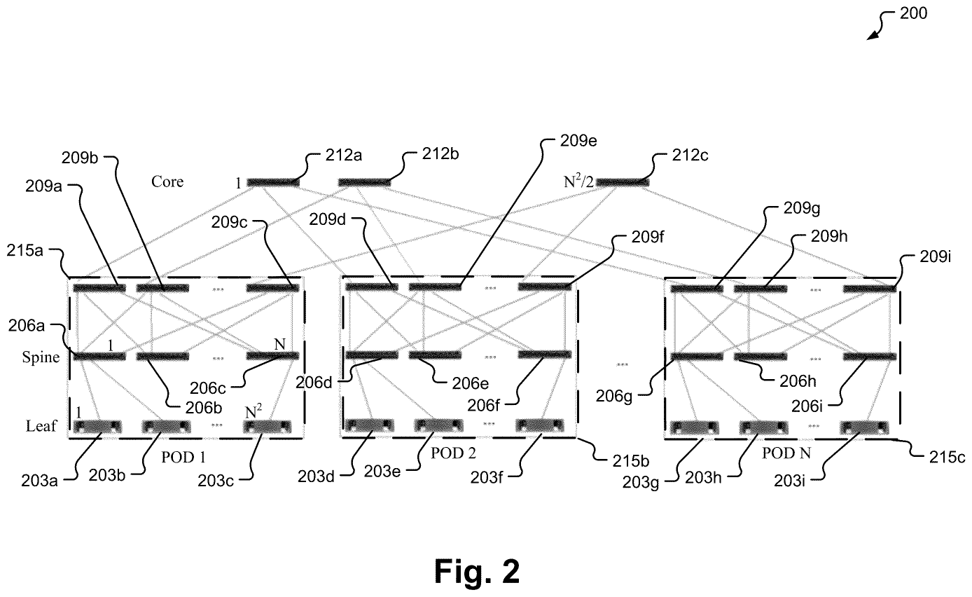

As illustrated in FIG. 2, a network 200 may include a number of devices such as leaf switches 203a-i, spine switches 206a-i, super spine switches 209a-i, and core switches 212a-c. A device, such as the leaf switches 203a-i, spine switches 206a-i, super spine switches 209a-i, and core switches 212a-c illustrated in FIG. 2, as described herein may be any type of computing system which includes one or more ports for sending and/or receiving data. The ports of a device may be used to connect a device with other devices. For example, ports of a leaf switch 203a-i may be connected to other such as leaf switches 203a-i, spine switches 206a-i, super spine switches 209a-i, and/or core switches 212a-c. Ports of a spine switch 206a-i may be connected to leaf switches 203a-i, other spine switches 206a-i, super spine switches 209a-i, and/or core switches 212a-c. Ports of a super spine switch 209a-i may be connected to leaf switches 203a-i, spine switches 206a-i, other super spine switches 209a-i, and/or core switches 212a-c. Ports of a core switch 212a-c may be connected to leaf switches 203a-i, spine switches 206a-i, super spine switches 209a-i, and/or other core switches 212a-c. A device as described herein may be a computing system, switch, network device, and/or other devices capable of performing as a node of a network 200. A device may be referred to herein as a node or switch. Interconnected devices, such as the leaf switches 203a-i, spine switches 206a-i, super spine switches 209a-i, and core switches 212a-c illustrated in FIG. 2, form the network 200. Each device may be, for example, a server or a switch in a pod 115a-c. As illustrated in FIG. 2, leaf switches 203a-c, spine switches 206a-c, and super spine switches 209a-c form a first pod 115a, leaf switches 203d-f, spine switches 206 d-f, and super spine switches 209d-f form a second pod 115b, and leaf switches 203g-i, spine switches 206g-i, and super spine switches 209g-i form a third pod 115c. For example, a device may operate as a leaf device 203a-i, a spine device 206a-i, a super spine device 209a-i, a core switch 212a-c, and/or a device of a different level, and may connect to other devices on any level. Connections between devices may be within a server rack, within a pod 115a-c, between server racks, between pods 115a-c, and/or between server racks or pods 115a-c in different buildings and/or on different floors of a building.

As illustrated in FIG. 2, the devices may be arranged in N pods 115a-c interconnected by N²/2 core switches 212a-c. Each pod may contain N² leaf switches 203, N spine switches 206, and N super spine switches 209. As an example, in some implementations, the devices may be arranged in four pods interconnected by eight core switches 212 and each pod may contain sixteen leaf switches 203, four spine switches 206, and four super spine switches 209. While the network 200 appears in FIG. 2 as being of a particular topology, it should be appreciated that the systems and methods described herein may be used in relation to any network topology, including connecting a single device to one other device, and may include any number of leaf switches 203a-i, spine switches 206a-i, super spine switches 209a-i, core switches 212a-c, and pods 215a-c. Such a network 200 of device may be useful in various settings, from data centers and cloud computing infrastructures to artificial intelligence systems.

Devices, as described in greater detail herein, may enable communication between nodes of a network. A device may be, for example, a switch, a NIC, or other device capable of receiving and sending data, and may act as a central node in the network 200 or any node in the network 200. Devices may be wired in a topology including spine switches, top-of-rack (TOR) switches, and/or leaf switches, for example. A TOR switch may be, for example, any suitable type of type of networking device that connects multiple computers in a single physical location. The systems and methods described herein may also be used to provide secure communication between devices in different physical locations. Devices may be capable of receiving, processing, and forwarding data, e.g., packets, to appropriate nodes within the network, such as switches. In some implementations, a device may be included in a switch box, a platform, or a case which may contain one or more devices as well as one or more power supply devices and other components.

Each device may, for example, include one or more processing circuits, such as graphics processing units (GPUs), central processing units (CPUs), data processing units (DPUs), quantum processing units (QPUs), a plurality of parallel processing units (PPUs), application-specific integrated circuits (ASICs), field programmable gate arrays (FPGAs), or other circuitry capable of performing computations, as well as memory and storage resources to run software applications, handle data processing, and perform specific tasks as required. In some implementations, devices may also or alternatively include hardware such as GPUs for handling intensive tasks for machine learning, artificial intelligence (AI) workloads, or other complex processes.

QPUs configured to perform one or more operations associated with a quantum algorithm In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

For example, devices may operate as a high-performance computing (HPC) cluster. A cluster of devices may comprise numerous interconnected servers, each equipped with CPUs and/or GPUs. The devices may provide computational horsepower for, as an example, training large-scale AI models or running complex scientific simulations. For AI and machine learning tasks, the devices may comprise one or more GPUs or other processing circuitry which may be capable of handling parallel processing requirements of neural networks and other applications.

Devices may be client devices which, for example, engage in AI-related, research-related, and other processor-intensive tasks, and utilize a network of devices to handle the computational loads and data throughput required by such intensive applications. Such devices may include, for example, workstations and personal computers used by researchers, data scientists, and professionals for developing, testing, and running AI models and research simulations.

As illustrated in FIG. 2, a number of devices, such as leaf switches 203a-i, spine switches 206a-i, super spine switches 209a-i, and/or core switches 212a-c may be interconnected to form a network 200. Each line in FIG. 2 connecting two devices may represent any number of one or more connections between the devices. For example, ports of a first leaf switch 203a may be connected to one or more ports of a first spine switch 206a, one or more ports of a second spine switch 206b, and one or more ports of a third spine switch 206c. As should be appreciated, the specific interconnections of the devices illustrated by FIG. 2 are provided for illustration purposes only and should not be considered as limiting in any way. While the network illustrated in FIG. 2 only includes four layers of devices, it should be appreciated additional layers may be introduced and devices may be interconnected in any conceivable manner. For example, in some implementations, a network as described herein may contain multiple devices interconnected in a topology such as a Clos network or a fat tree topology network.

Connections between devices may include server-to-server links, rack-to-rack links, floor-to-floor links, and site-to-site links. A server-to-server link may be a link between servers in a single rack within a data center. This involves establishing secure quantum links between individual servers to protect sensitive data. A rack-to-rack link may be a link between servers in different racks. This involves securing communication between different server racks within the data center, ensuring data integrity and security across larger sections of the infrastructure. A floor-to-floor link may be a link between servers in different physical locations within a single building. A site-to-site link may be a link between servers in different buildings. Each link may provide QKD capabilities, enabling QKD-enhanced cyber security between devices. As should be appreciated, a QKD link utilizing the systems and methods described herein may be used to provide secure connections between any number of devices in any number of locations.

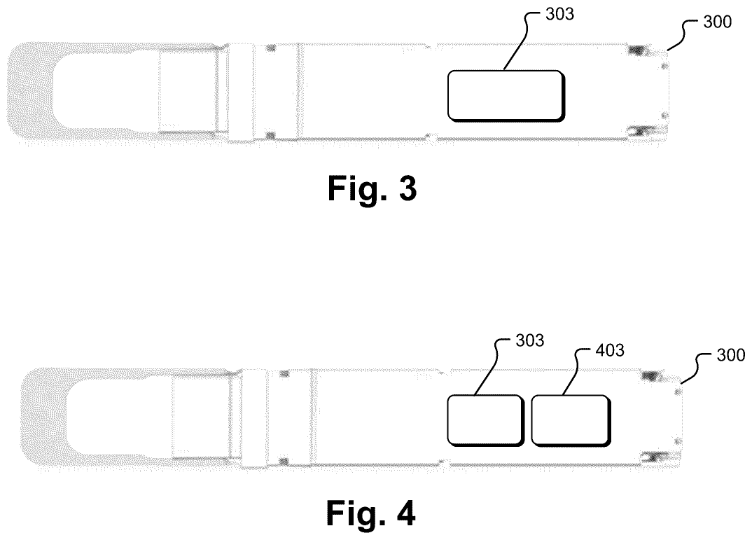

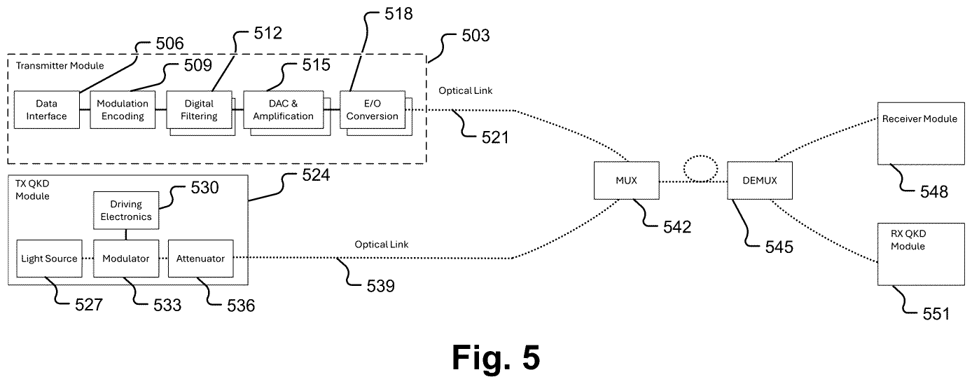

The connections between devices may be facilitated by transceivers 300 as illustrated in FIGS. 3 and 4. A transceiver 300 as described herein may be an optical transceiver and configured to enable communication between devices, such as leaf switches 203a-i, spine switches 206a-i, super spine switches 209a-i, core switches 212a-c, NICs, and/or any other device, by facilitating the transmission and reception of data over optical fiber. A transceiver 300 may be housed in a form factor such as Small Form-factor Pluggable (SFP), Quad Small Form-factor Pluggable (QSFP), Octal Small Form-factor Pluggable (OSFP) or another type of module. In some implementations, a transceiver 300 may integrate both a transmitter and a receiver within a single unit, enabling bidirectional transmission over either a single fiber optic cable, using multiplexing techniques, or separate fibers for dedicated transmission and reception pathways. A transceiver 300 may also or alternatively integrate a QKD circuit 303 as described in greater detail below in addition to or instead of an optical data system 403 as described in greater detail below.

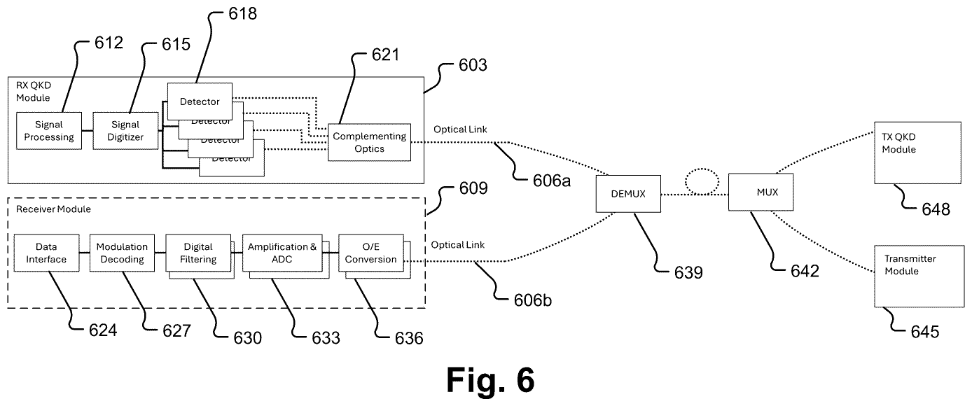

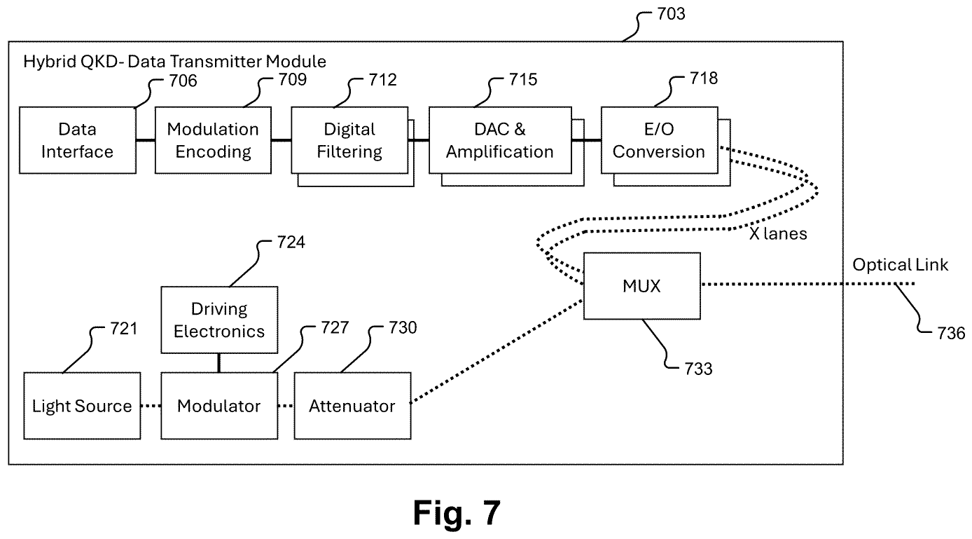

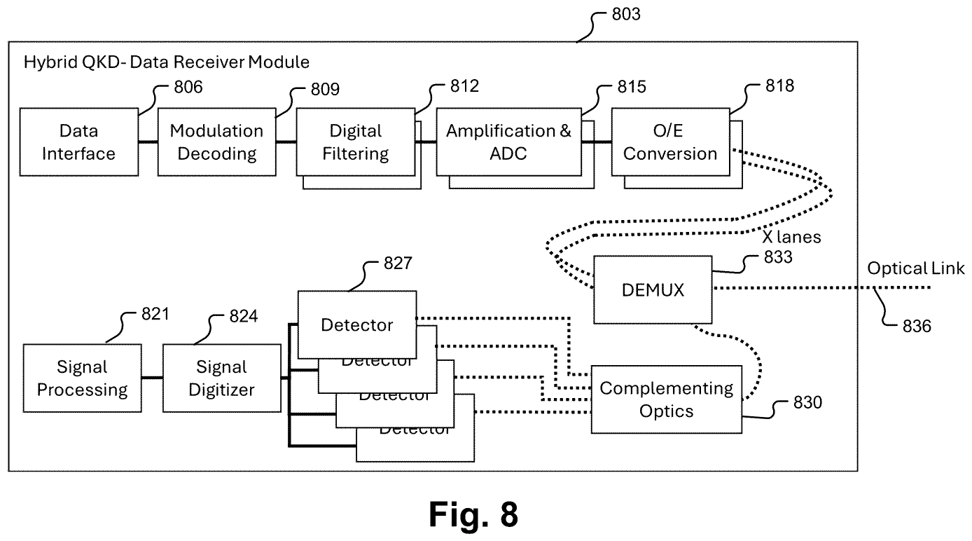

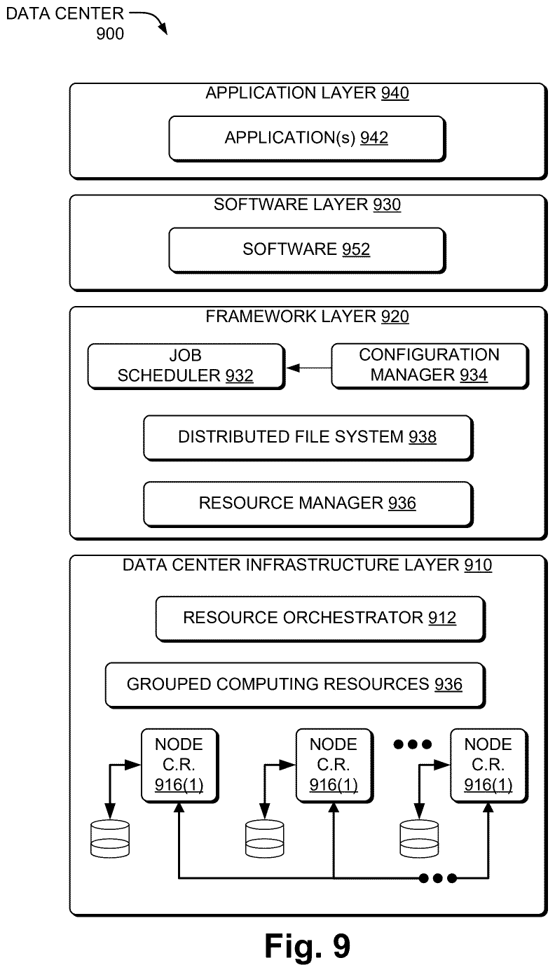

A QKD circuit 303 may include a transmit (TX) QKD module 524 as illustrated and described below in relation to FIG. 5 and/or a receive (RX) QKD module 551 as illustrated and described below in relation to FIG. 6. An optical data system 403 may optionally include a transmitter module 503 (which may be referred to as a data transmitter circuit) as illustrated and described below in relation to FIG. 5 and/or a receiver module 548 as illustrated and described below in relation to FIG. 6. A transceiver 300 may also, in some implementations, include a multiplexer (MUX) 542 and/or a de-multiplexer (DEMUX) 545 as described below in relation to FIGS. 5 and 6. Furthermore, in some implementations, a transceiver 300 may include a hybrid QKD-data transmitter module 703 which may include components of a TX QKD module 524 and components of a transmitter module 503 in addition to a MUX 542 and an optical link or optical fiber 554 as illustrated in FIG. 7. In the same and/or other implementations, a transceiver 300 may include a hybrid QKD-data receiver module 803 which may include components of an RX QKD module 551 and components of a receiver module 548 in addition to a DEMUX 545 and an optical link or optical fiber 554 as illustrated in FIG. 8.

The transceiver 300 illustrated in FIG. 3 lacks an optical data system 403. As such, the transceiver 300 of FIG. 4 may include the QKD circuit 303 which may include a TX QKD module and/or an RX QKD module as described herein. The transceiver illustrated in FIG. 4 includes the QKD circuit 303 in addition to an optical data system 403 which may include a transmitter module and/or a receiver module integrated on the same module as described herein. In some implementations, a transceiver 300 may include a hybrid QKD-data transmitter module and/or a hybrid QKD-data receiver module as described herein.

A transceiver 300 as described herein, which may be referred to as an apparatus, may be configured to provide high bandwidth, low latency, and reliability. In a data center, for example, where servers generate immense volumes of data for applications such as cloud computing, big data analytics, machine learning, and real-time streaming, a transceiver 300 may ensure seamless connectivity. A transceiver 300 may support a wide range of data rates, from 1 Gbps for basic applications to 800 Gbps or more. The optical signal from the optical interface may be a four-wavelength signal such as an 800GBASE-FR4 and operate at, for example, 800 Gb/s with four lanes, each at 200 Gb/s. For example, one or more of the interfaces of the system may include FR4 and/or DR4 optical interfaces in accordance with IEEE 802.3 400GBASE-FR4, -DR4, -SR4.2, etc. It should be appreciated the systems and methods described herein may be used with FR4 interfaces as well as any other form of interface. The present disclosure is intended to cover any type of high-speed pluggable interface and may assume any suitable type of known or yet-to-be developed form factor, such as which may be capable solely of hosting an optical connector. The systems and methods described herein may be used in relation to any form of optical signals sent using any type of protocol relating to, for example, WDM, coarse wavelength division multiplexing (CWDM), dense wavelength division multiplexing (DWDM), 800GBASE-FR4, 800GBASE-DR4, 400GBASE-SR4.2, 400ZR etc., or any combination thereof. A transceiver 300 may be configured to send and receive data over various distances, ranging from a few meters for short-range connections within a server rack to tens or even hundreds of kilometers for long-haul communication between data center locations.

### Use Cases:

| | | | Use Case 2 | | | |
|---|---|---|---|---|---|---|
| | Use Case 1: | | 800GBASE-DR4 | | | |
| | 800GBASE-FR4 | | transceivers | | Use Case 3 | |
| | transceiver | | over a dedicated link | | 400ZR | |
| Classical | 1264.5-1337.5 | nm | 1304.5-1317.5 | nm | 1529.8-1567.6 | nm |
| channel | | | | | | |
| wavelength | | | | | | |
| range | | | | | | |
| Quantum | C-band or L-band | | C-band or L-band | | L-band | |
| channel | | | | | | |
| wavelength | | | | | | |
| range | | | | | | |
| Reach | 2 km single-mode fiber | | 500 m single-mode fiber | | reach limited by 11 | |
| | (G.652 C/D or G.567 | | (G.652 C/D or G.567 | | dB link loss | |
| | A1/A2) | | A1/A2) | | definition | |
| Channel | 4 | dB | 3 | dB | 11 | dB |
| Insertion Loss | | | | | | |
| Optical return | 17.1 | dB | 21.4 | dB | 24 | dB |

loss tolerance
(max)

As illustrated in FIG. 5, a transmitter section of an optical transceiver 300 may be configured to transmit data from a device and/or establish a QKD link between the device and a device at a distant end of an optical fiber 554. It should be appreciated that in some implementations, a transceiver may include a TX QKD module 524 and may not include a data transmitter module 503. In such implementations, the MUX 542 may not be necessary.

A data transmitter module 503 may include one or more of a data interface 506, a modulation encoding system 509, one or more digital filtering systems 512, one or more DAC and/or amplification circuits 515, one or more electrical/optical (E/O) conversion circuits 518 and an output optical link 521. The data transmitter module 503 may be configured to prepare, modulate, and transmit data as optical signals via an output optical link 521.

A data interface 506 of a data transmitter module 503 may be configured to accept one or more digital data streams from a device to which the transceiver is connected, such as a server or a switch. The data interface 506 may be configured to ensure compatibility with a data standard (e.g., Ethernet) and to manage data flow, clock synchronization, and/or data buffering. The data interface 506 may also be configured to format input data for modulation and transmission.

A modulation encoding system 509 of a data transmitter module 503 may be configured to encode an input data signal received by a data interface 506 into a format suitable for optical transmission by optimizing the data signal to reduce error rates and ensure compatibility with the optical link 521. In some implementations, a modulation encoding system 509 may employ a modulation scheme such as non-return-to-zero, pulse amplitude modulation, quadrature phase-shift keying, or other schemes.

Digital filtering systems 512 of a data transmitter module 503 may be configured to refine a signal modulated by the modulation encoding system 509. A digital filtering system 512 may be implemented as one or more digital signal processing (DSP) algorithms and may be configured to eliminate unwanted frequency components and/or adjust a shape of the signal for transmission. A digital filter may be, for example, a low-pass or band-pass filter.

A DAC and/or amplification circuit 515 of a data transmitter module 503 may be configured to convert the digitally processed and modulated signal into an analog signal and/or to boost the analog signal to an appropriate power level required for outputting the analog signal as an optical signal and/or to drive the E/O conversion circuits 518.

E/O conversion circuits 518 of a data transmitter module 503 may be configured to convert electrical signals from the DAC and/or amplification circuit(s) 515 into optical signals that can travel through fiber optic cables. The E/O conversion circuits 518 may use a light source to modulate electrical signals, encoding data into the optical signal. The optical signal may be output onto the output optical link 521 and may be multiplexed with an optical signal output by the TX QKD module 524.

A TX QKD module 524 of a transmitter section may include one or more of a light source 527, driving electronics 530, a modulator 533, an attenuator 536, and an output optical link 539. The TX QKD module may be configured to establish a secure communication channel by leveraging quantum mechanics to generate and share encryption keys between a device connected to the transceiver and a device connected to a transceiver at another end of the optical fiber 554.

A light source 527 of a TX QKD module 524 may, for example, include a laser diode and may be configured to generate photons or quantum light pulses. The light source 527 may be tuned to emit photons at a specific desired wavelength or range of wavelengths.

Driving electronics 530 of a TX QKD module 524 may be configured to control the light source 527, modulator 533, and/or other components of the TX QKD module 524. The driving electronics 530 may generate precise timing signals and control the modulator 533 such that light pulses from the light source 527 encode quantum information.

A modulator 533 of a TX QKD module 524 may be configured to encode or imprint quantum states onto the photons generated by the light source 527. In polarization-based QKD, for example, the modulator 533 may adjust the polarization of each photon to encode a bit value (0 or 1). However, it should be appreciated that other types of QKD may be performed by the TX QKD module 524. A modulator 533 as described herein may be considered a QKD circuit configured to encode one or more photons according to respective quantum states.

An attenuator 536 of a TX QKD module 524 may control the intensity of the modulated photon(s) output to reduce the intensity to quantum levels. The attenuator 536 may output the photon(s) onto the optical link 539. An attenuator 536 as described herein may be considered a quantum transmitter circuit configured to enable encoded photons to transmit via an optical communication channel such as the optical link 539. The optical link 539 may be or include an optical fiber and may serve as a quantum channel for photon transmission.

In implementations of a transceiver including both a data transmitter module 503 and a TX QKD module 524, the photons output by the TX QKD module 524 may be multiplexed with data output by the transmitter module 503 by a MUX 542 before being output from the transceiver onto one or more optical fibers 554.

The transceiver may output the encoded photons with or without a multiplexed data signal from a transmitter module 503 onto the optical fibers 554. In some implementations, the transceiver may not include a data transmitter module 503. In some implementations, the transceiver may output encoded photons from a TX QKD module 524 and a data signal from a transmitter module 503 onto respective optical fibers 554 without the use of a MUX 542.

At a distal end of the optical fiber 554, a receiving section 563 of a transceiver may be configured to receive the encoded photons with or without a multiplexed data signal. The receiving section 563 may include a DEMUX 545 configured to demultiplex a received signal into a QKD signal and a data signal. The QKD signal may be output by the DEMUX 545 onto a first optical link 560 and the data signal may be output by the DEMUX 545 onto a second optical link 557. The first optical link 560 may be connected to a receive (RX) QKD module 551 and the second optical link 557 may be connected to a data receiver module 548. The RX QKD module 551 and the data receiver module 548 may include components as illustrated in FIG. 6 and as described below.

For example, as illustrated in FIG. 6, a receive section of a transceiver may include an RX QKD module 603 and a data receiver module 609. The RX QKD module 603 and the data receiver module 609 may each be connected to a DEMUX 639 via a respective optical link 606a, 606b.

A data receiver module 609 of a transceiver may include one or more data interfaces 624, modulation decoding circuits 627, digital filtering circuits 630, amplification and ADC circuits 633, and/or optical-to-electrical (O/E) conversion circuits 636, and may be configured to receive an optical signal via an optical link 606b.

The optical link 606b may serve as an input for the receiver module 609 and may enable the receiver module 609 to receive optical signals sent from another device via another transceiver connected to the transceiver via an optical fiber. The optical signal may be demultiplexed by a DEMUX 639 before being received by the data receiver module 609.

O/E conversion circuits 636 of a data receiver module 609 may be configured to receive an optical signal via the optical link 606b and convert the incoming optical signal into an electrical signal for further processing. The O/E conversion circuits 636 may for example use one or more photodetectors to generate an electrical current proportional to the intensity of received light.

Amplification and ADC circuits 633 of a data receiver module 609 may be configured to boost the electrical signal converted by the O/E conversion circuits 636 to levels required for accurate analog-to-digital conversion and digitize the amplified signal, converting it into a digital signal.

Digital filtering circuits 630 of a data receiver module 609 may be configured to process the digital signal to remove noise, correct distortions, and/or enhance the overall quality of the signal. Digital filtering circuits 630 may be implemented using DSP techniques and filters such as low-pass and band-pass filters.

Modulation decoding circuits 627 of a data receiver module 609 may be configured to extract data from the processed signal. Modulation decoding circuits 627 may reverse modulation applied by a transmitter module, converting the signal back to its original digital form.

Data interfaces 624 of a data receiver module 609 may be configured to output the decoded digital data from the transceiver to a device, such as a server, switch, or other computing system. The data interface 624 may in some implementations be configured format the data to conform to one or more communication standards (e.g., Ethernet or InfiniBand).

An RX QKD module 603 may include one or more signal processing circuits 612, a signal digitizer 615, one or more detectors 618 and complementing optics 621, and may be configured to receive an optical signal via an optical link 606a. The RX QKD module 603 may be a circuit configured to decode and process quantum-encoded optical signals to extract cryptographic key data securely by measuring and interpreting quantum information encoded in one or more individual photons. In some implementations, the RX QKD module 603 may be configured to detect a transmission which includes one or more photons per symbol. For example, the RX QKD module 603 may be configured to receive single-photon transmissions in which a symbol is encoded using a single photon and/or multi-photon transmissions in which a symbol is encoded using multiple photons.

The RX QKD module 603 may receive a quantum optical signal transmitted through an optical link 606a. The quantum optical signal may be received by the transceiver via an optical link 606a with or without a multiplexed data signal. In some implementations, a DEMUX 639 may be used to de-multiplex the quantum optical signal from a data signal.

Complementing optics 621 of an RX QKD module 603 may be configured to receive the quantum optical signal via the optical link 606a and prepare the quantum optical signal for measurement. Complementing optics 621 may include, for example, one or more polarizers, beam splitters, wavelength filters, optical delay lines, interferometers, and/or other components capable of managing and directing a photon stream.

Detectors 618 of an RX QKD module 603 may be photon detectors and may be capable of converting a quantum optical signal into an electrical signal. The detectors 618 may be configured to detect individual photons and measure specific quantum properties of the photons, such as polarization, phase, or time-bin, depending on the QKD protocol used (e.g., BB84, E91, or continuous-variable QKD). The detectors 618 may generate electrical pulses corresponding to the arrival of each photon and its measured state.

A signal digitizer 615 of an RX QKD module 603 may be a circuit configured to process electrical pulses from one or more detectors 618 and convert the pulses into digital signals for further processing. The signal digitizer 615 may include, for example, analog-to-digital converters (ADCs) or time-to-digital converters (TDCs).

Signal processing circuits 612 of an RX QKD module 603 may be configured to interpret digitized signals to reconstruct quantum key material. Signal processing circuits 612 may be configured to perform one or more of basis reconciliation, error correction, amplification, synchronization, and/or other functions using, for example, DSP algorithms and/or hardware accelerators.

Each of the components of the transmitter module, TX QKD module 424, receiver module 609, and the RX QKD module 603 described above may be miniaturized components such that the components may be contained within a single pluggable transceiver. For example, one or more of the transmitter module 645, TX QKD module 648, receiver module 609, and the RX QKD module 603 may be an integrated circuit (IC) or a system-on-chip (SoC) including circuit components capable of performing the above-discussed features. As illustrated in FIG. 7, a transceiver may include a hybrid QKD-data transmitter module 703 which may be a miniaturized IC or SoC capable of performing the functions of both the TX QKD module 524 and the receiver module 609. As illustrated in FIG. 8, a transceiver may include a hybrid QKD-data receiver module 803 which may be a miniaturized IC or SoC capable of performing the functions of both the receiver module 609 and the RX QKD module 603 described above. As should be appreciated, a transceiver may include any combination of the transmitter module, TX QKD module 524, receiver module 609, RX QKD module 603, hybrid QKD-data transmitter module 703, and hybrid QKD-data receiver module 803 as described above.

By implementing a TX QKD module 524 and/or an RX QKD module 603 (or hybrid QKD-data transmitter module 703 and/or hybrid QKD-data receiver module 803) within a pluggable transceiver, QKD links may be established between servers on a single rack, between server racks on a floor of a data center, between floors of a data center, between data center sites, and/or between devices in any location.

Any combination of the transmitter module 503, TX QKD module 524, receiver module 609, RX QKD module 603, hybrid QKD-data transmitter module 703, and hybrid QKD-data receiver module 803 as described above may be implemented on a dedicated printed circuit board (PCB), chiplet, IC, SoC, or other component type or subsystem.

The components of a transceiver, including one or more of a transmitter module 503, TX QKD module 524, receiver module 609, RX QKD module 603, hybrid QKD-data transmitter module 703, and hybrid QKD-data receiver module 803 as described above may be contained within a pluggable body, forming a pluggable QKD-capable transceiver. For example, a transceiver may be a mid-board optical module (MBOM), a linear pluggable optics (LPO) transceiver, a quad small form-factor pluggable (QSFP) transceiver, a quad small form-factor pluggable double density (QSFP-DD) transceiver, or another type of transceiver.

In some implementations, a dedicated pluggable module may include one of a transmitter module 503, TX QKD module 524, receiver module 609, RX QKD module 603, hybrid QKD-data transmitter module 703, or a hybrid QKD-data receiver module 803 as described above. For example, each of the transmitter module 503, TX QKD module 524, receiver module 609, RX QKD module 603, hybrid QKD-data transmitter module 703, and hybrid QKD-data receiver module 803 may be implemented as a separate, dedicated pluggable module. Such a one-sided transceiver may be capable of sending or receiving.

In other implementations, a bi-directional pluggable transceiver may include a TX QKD module 524 and an RX QKD module 603 and may or may not be configured to send and receive data signals in addition to a quantum optical signal. A transceiver may be configured to provide a dedicated fiber link for a quantum optical signal, without a data signal multiplexed with the quantum optical signal.

In some implementations, a device may be an optical switch with transmit and receive capabilities configured to enable a point-to-multipoint solution for QKD cyber security. A transceiver as described herein may be hard-wired in the device and may not be a pluggable module.

In some implementations, a transceiver as described herein, containing one or more of a TX QKD module 524, an RX QKD module 603, a hybrid QKD-data transmitter module 703, and/or a hybrid QKD-data receiver module 803 may be implemented as a co-packaged optics (CPO) package in which optical and electrical components are co-located in a single package. For example, a CPO package may include components of a TX QKD module 524, an RX QKD module 603, a hybrid QKD-data transmitter module 703, and/or a hybrid QKD-data receiver module 803 along with electronic components such as switches, processors, ASICs, and other componentry integrated into a single microchip. The electronic components of the CPO package may be configured to perform processing or switching functions in relation to the QKD functionality of the TX QKD module 524, RX QKD module 603, hybrid QKD-data transmitter module 703, and/or hybrid QKD-data receiver module 803.

In some implementations, the TX QKD module 524, RX QKD module 603, hybrid QKD-data transmitter module 703, and/or hybrid QKD-data receiver module 803 of a transceiver may receive power needed to implement the QKD functionality via a device to which the transceiver is connected, such as via a pluggable connection.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. The systems and methods described herein may be used in augmented reality, virtual reality, mixed reality, robotics, security and surveillance, autonomous or semi-autonomous machine applications, and/or any other technology spaces in which one or more signal conductors may have at least two different states that consume different amounts of power.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, web-hosted services or web-hosted platforms, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for implementing web-hosted services (e.g., for program optimization at runtime) or web-hosted platforms (e.g., integrated development environments that include program optimization as a service), as an application programming interface (“API”) between two or more separate applications or systems, and/or other types of systems.

### Data Center

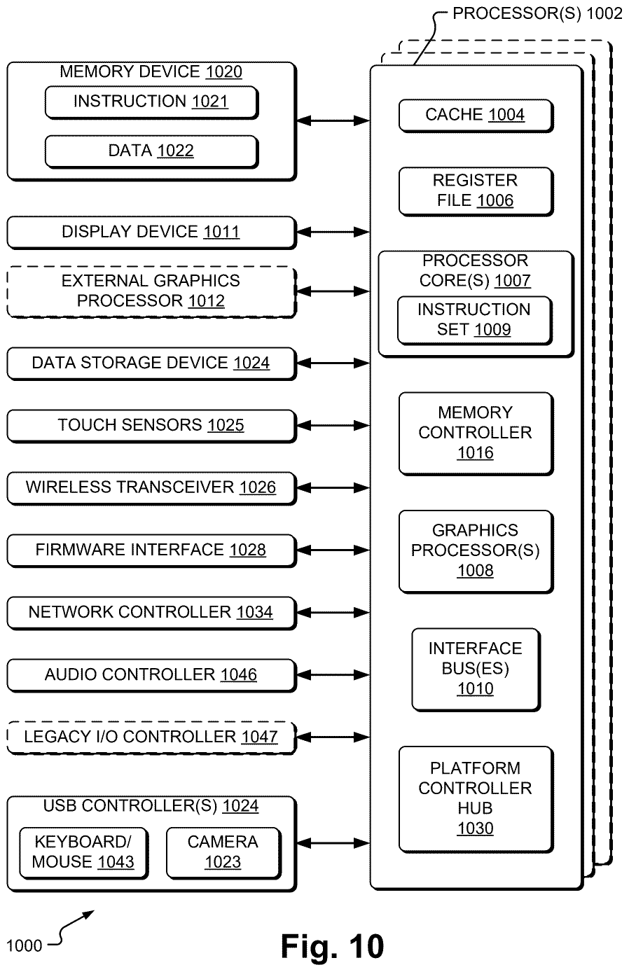

FIG. 9 illustrates an example data center 900, in accordance with at least one embodiment. In at least one embodiment, data center 900 includes, without limitation, a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 936, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-916(N) and/or grouped computing resources 914. In at least one embodiment, resource orchestrator 912 may include a software design infrastructure (“SDI”) management entity for data center 900. In at least one embodiment, resource orchestrator 912 may include hardware, software, or some combination thereof.

In at least one embodiment, as shown in FIG. 9, framework layer 920 includes, without limitation, a job scheduler 932, a configuration manager 934, a resource manager 936 and a distributed file system 938. In at least one embodiment, framework layer 920 may include a framework to support software 952 of software layer 930 and/or one or more application(s) 942 of application layer 940. In at least one embodiment, software 952 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920, including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 952 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. In at least one or more types of applications may include, without limitation, CUDA applications.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, the data center 900 may utilize one or more transceivers 300 with QKD functionality such as illustrated in FIG. 3. In at least one embodiment, one or more systems depicted in FIG. 9 are utilized to implement one or more systems and/or processes such as those described in connection with FIGS. 1-8.

### Computer-Based Systems

The following figures set forth, without limitation, example computer-based systems that can be used to implement at least one embodiment.

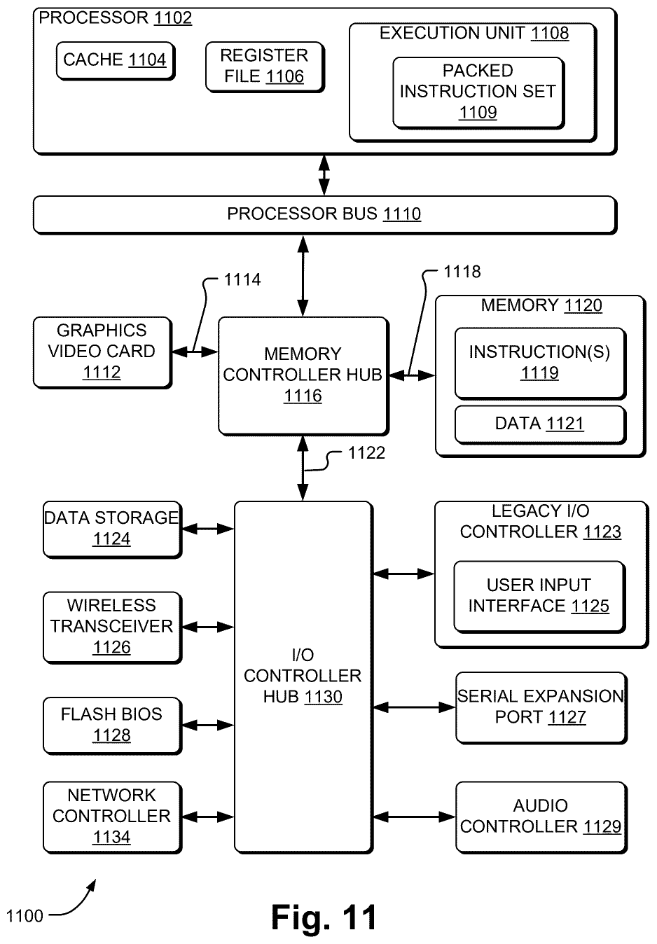

FIG. 10 illustrates a processing system 1000, in accordance with at least one embodiment. In at least one embodiment, processing system 1000 includes one or more processors 1002 and one or more graphics processors 1008, and may be a single processor desktop system, a multiprocessor workstation system, or a server system having a large number of processors 1002 or processor cores 1007. In at least one embodiment, processing system 1000 is a processing platform incorporated within a system-on-a-chip (“Sort”) integrated circuit for use in mobile, handheld, or embedded devices.

In at least one embodiment, processing system 1000 can include, or be incorporated within a server-based gaming platform, a game console, a media console, a mobile gaming console, a handheld game console, or an online game console. In at least one embodiment, processing system 1000 is a mobile phone, smart phone, tablet computing device or mobile Internet device. In at least one embodiment, processing system 1000 can also include, couple with, or be integrated within a wearable device, such as a smart watch wearable device, eyewear device, augmented reality device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (“CISC”), Reduced Instruction Set Computing (“RISC”), or computing via a Very Long Instruction Word (“VLIW”). In at least one embodiment, processor cores 1007 may each process a different instruction set 1009, which may include instructions to facilitate emulation of other instruction sets. In at least one embodiment, processor core 1007 may also include other processing devices, such as a digital signal processor (“DSP”).

In at least one embodiment, processor 1002 includes cache memory (‘cache”) 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level 3 (“L3”) cache or Last Level Cache (“LLC”)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in processing system 1000. In at least one embodiment interface bus 1010, in one embodiment, can be a processor bus, such as a version of a Direct Media Interface (“DMI”) bus. In at least one embodiment, interface bus 1010 is not limited to a DMI bus and may include one or more Peripheral Component Interconnect buses (e.g., “PCI,” PCI Express (“PCIe”)), memory buses, or other types of interface buses. In at least one embodiment processor(s) 1002 include an integrated memory controller 1016 and a platform controller hub 1030. In at least one embodiment, memory controller 1016 facilitates communication between a memory device and other components of processing system 1000, while platform controller hub (“PCH”) 1030 provides connections to Input/Output (“I/O”) devices via a local I/O bus.

In at least one embodiment, memory device 1020 can be a dynamic random-access memory (“DRAM”) device, a static random-access memory (“SRAM”) device, flash memory device, phase-change memory device, or some other memory device having suitable performance to serve as processor memory. In at least one embodiment memory device 1020 can operate as system memory for processing system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (“HMD”) such as a stereoscopic display device for use in virtual reality (“VR”) applications or augmented reality (“AR”) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as PCI, or PCIe. In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (“LTE”) transceiver. In at least one embodiment, firmware interface 1028 enables communication with system firmware, and can be, for example, a unified extensible firmware interface (“UEFI”). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, processing system 1000 includes an optional legacy I/O controller 1047 for coupling legacy (e.g., Personal System 2 (“PS/2”)) devices to processing system 1000. In at least one embodiment, platform controller hub 1030 can also connect to one or more Universal Serial Bus (“USB”) controllers 1024 connect input devices, such as keyboard and mouse 1043 combinations, a camera 1023, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, processing system 1000 can include an external memory controller 1016 and platform controller hub 1030, which may be configured as a memory controller hub and peripheral controller hub within a system chipset that is in communication with processor(s) 1002.

In at least one embodiment, the processing system 1000 may utilize a transceiver with QKD functionality in a network 200 such as illustrated in FIG. 2. In at least one embodiment, the interface bus 1010 may be used to implement QKD functionality via a transceiver. In at least one embodiment, one or more systems depicted in FIG. 10 are utilized to implement one or more systems and/or processes such as those described in connection with FIGS. 1-8.

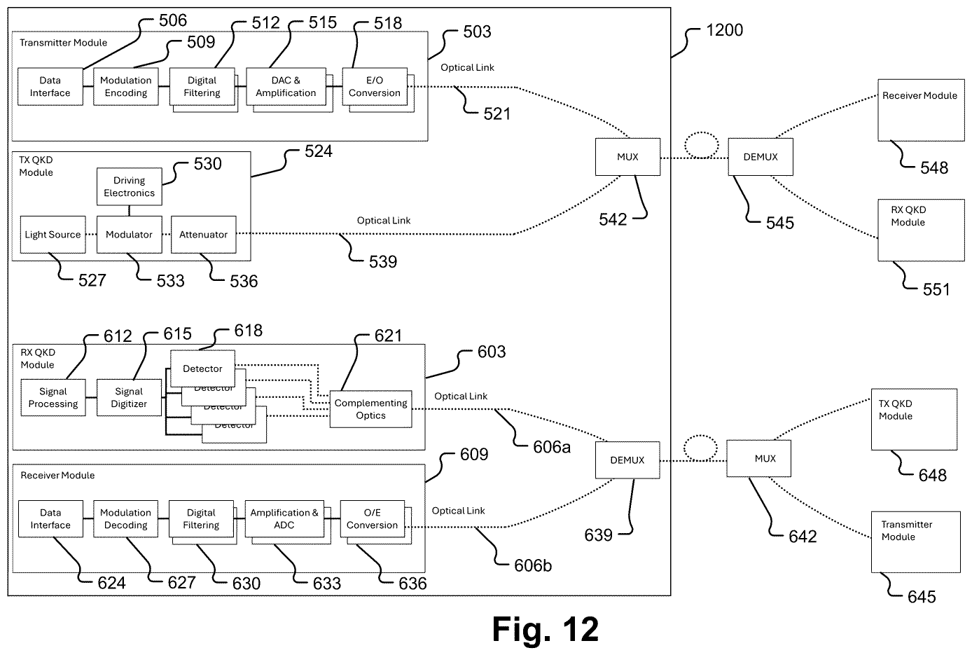

FIG. 11 illustrates a computer system 1100, in accordance with at least one embodiment. In at least one embodiment, computer system 1100 may be a system with interconnected devices and components, an SOC, or some combination. In at least one embodiment, computer system 1100 is formed with a processor 1102 that may include execution units to execute an instruction. In at least one embodiment, computer system 1100 may include, without limitation, a component, such as processor 1102 to employ execution units including logic to perform algorithms for processing data. In at least one embodiment, computer system 1100 may include processors, such as PENTIUM® Processor family, Xeon™, Itanium®, XScale™ and/or StrongArm™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1100 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 1100 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“Net PCs”), set-top boxes, network hubs, wide area network (“WAN”) switches, or any other system that may perform one or more instructions.

In at least one embodiment, computer system 1100 may include, without limitation, processor 1102 that may include, without limitation, one or more execution units 1108 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 1100 is a single processor desktop or server system. In at least one embodiment, computer system 1100 may be a multiprocessor system. In at least one embodiment, processor 1102 may include, without limitation, a CISC microprocessor, a RISC microprocessor, a VLIW microprocessor, a processor implementing a combination of instruction sets, or any other processor device, such as a digital signal processor, for example. In at least one embodiment, processor 1102 may be coupled to a processor bus 1110 that may transmit data signals between processor 1102 and other components in computer system 1100.

In at least one embodiment, processor 1102 may include, without limitation, a Level 1 (“L1”) internal cache memory (“cache”) 1104. In at least one embodiment, processor 1102 may have a single internal cache or multiple levels of internal cache. In at least one embodiment, cache memory may reside external to processor 1102. In at least one embodiment, processor 1102 may also include a combination of both internal and external caches. In at least one embodiment, a register file 1106 may store different types of data in various registers including, without limitation, integer registers, floating point registers, status registers, and instruction pointer register.

In at least one embodiment, execution unit 1108, including, without limitation, logic to perform integer and floating-point operations, also resides in processor 1102. Processor 1102 may also include a microcode (“ucode”) read only memory (“ROM”) that stores microcode for certain macro instructions. In at least one embodiment, execution unit 1108 may include logic to handle a packed instruction set 1109. In at least one embodiment, by including packed instruction set 1109 in an instruction set of a general-purpose processor 1102, along with associated circuitry to execute instructions, operations used by many multimedia applications may be performed using packed data in a general-purpose processor 1102. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 1108 may also be used in microcontrollers, embedded processors, graphics devices, DSPs, and other types of logic circuits. In at least one embodiment, computer system 1100 may include, without limitation, a memory 1120. In at least one embodiment, memory 1120 may be implemented as a DRAM device, an SRAM device, flash memory device, or other memory device. Memory 1120 may store instruction(s) 1119 and/or data 1121 represented by data signals that may be executed by processor 1102.

In at least one embodiment, a system logic chip may be coupled to processor bus 1110 and memory 1120. In at least one embodiment, the system logic chip may include, without limitation, a memory controller hub (“MCH”) 1116, and processor 1102 may communicate with MCH 1116 via processor bus 1110. In at least one embodiment, MCH 1116 may provide a high bandwidth memory path 1118 to memory 1120 for instruction and data storage and for storage of graphics commands, data, and textures. In at least one embodiment, MCH 1116 may direct data signals between processor 1102, memory 1120, and other components in computer system 1100 and to bridge data signals between processor bus 1110, memory 1120, and a system I/O 1122. In at least one embodiment, system logic chip may provide a graphics port for coupling to a graphics controller. In at least one embodiment, MCH 1116 may be coupled to memory 1120 through high bandwidth memory path 1118 and graphics/video card 1112 may be coupled to MCH 1116 through an Accelerated Graphics Port (“AGP”) interconnect 1114.

In at least one embodiment, computer system 1100 may use system I/O 1122 that is a proprietary hub interface bus to couple MCH 1116 to I/O controller hub (“ICH”) 1130. In at least one embodiment, ICH 1130 may provide direct connections to some I/O devices via a local I/O bus. In at least one embodiment, local I/O bus may include, without limitation, a high-speed I/O bus for connecting peripherals to memory 1120, a chipset, and processor 1102. Examples may include, without limitation, an audio controller 1129, a firmware hub (“flash BIOS”) 1128, a wireless transceiver 1126, a data storage 1124, a legacy I/O controller 1123 containing a user input interface 1125 and a keyboard interface, a serial expansion port 1127, such as a USB, and a network controller 1134. Data storage 1124 may comprise a hard disk drive, a floppy disk drive, a CD-ROM device, a flash memory device, or other mass storage device.

In at least one embodiment, FIG. 11 illustrates a system, which includes interconnected hardware devices or “chips.” In at least one embodiment, FIG. 11 may illustrate an example SoC. In at least one embodiment, devices illustrated in FIG. 11 may be interconnected with proprietary interconnects, standardized interconnects (e.g., PCIe), or some combination thereof. In at least one embodiment, one or more components of system 1100 are interconnected using compute express link (“CXL”) interconnects.

In at least one embodiment, the computer system 1100 may utilize a transceiver with QKD functionality in a network 200 such as illustrated in FIG. 2. In at least one embodiment, the processor bus 1110 may be used to implement QKD functionality via a transceiver. In at least one embodiment, one or more systems depicted in FIG. 11 are utilized to implement one or more systems and/or processes such as those described in connection with FIGS. 1-8.

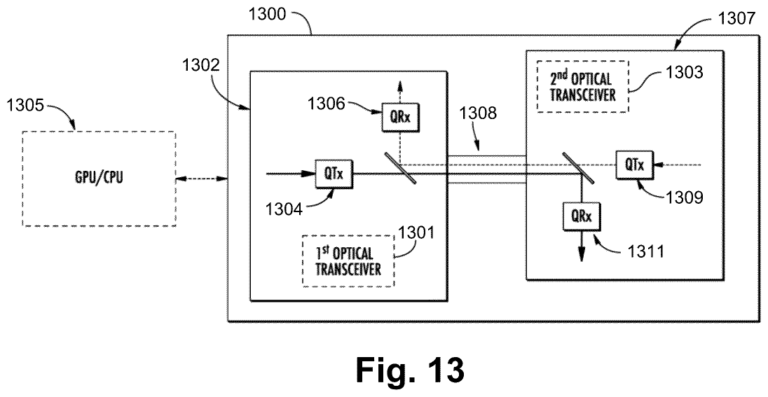

In at least one embodiment, a QKD-enabled transceiver 1200 as illustrated in FIG. 12 may include one or more of a transmitter module 503 and a TX QKD module 524 as illustrated and described above in relation to FIG. 5, as well as an RX QKD module 603 and a receiver module 609 as illustrated and described above in relation to FIG. 6. The transmitter module 503 and the TX QKD module 524 may output signals on respective optical links 521, 539 which may be multiplexed at a MUX 542 before being output from the transceiver 1200. Output signals from the transmitter module 503 and/or the TX QKD module 524 may be received at a DEMUX 545 where the signals may be de-multiplexed and received at a respective receiver module 609 and/or an RX QKD module 603.

The RX QKD module 603 and the receiver module 609 of the transceiver 1200 may receive signals via respective optical links 606a, 606b which may have been received by the transceiver 1200 over a single optical fiber and have been de-multiplexed at a DEMUX 639. The optical signal received at the DEMUX 639 may have been sent via a TX QKD module 648 and/or a transmitter module 645 as described above and may have been multiplexed at a MUX 642 before being sent to the transceiver over the single optical fiber.

### Bi-Directional Quantum Interconnects

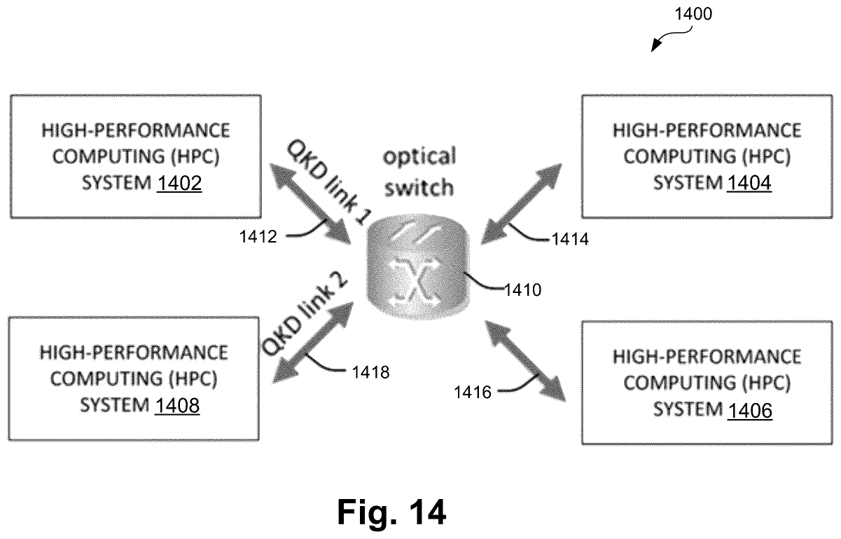

With reference to FIG. 13, an example bi-directional quantum interconnect 1300 (e.g., interconnect 1300) is illustrated. As shown, the interconnect 1300 may include a first communication module 1302 and a second communication module 1307 communicably coupled by a first communication medium 1308. The first communication module 1302 may include a first quantum transmitter 1304 configured to generate quantum particles (e.g., qubit) for transmission. A photon refers to a fundamental unit of electromagnetic radiation and, in quantum communication systems, may serve as the object within which data is encoded. The quantum basis of the qubits refers to the way in which data is encoded and/or the quantum information is carried, by the first quantum transmitter 1304, where the data is the value of the encoded information. This encoding may be accomplished via sets of orthogonal quantum states, including, but not limited to, pairs of photonic polarization states, phase of single photons, time of arrival, optical frequency, quadratures, etc. The pairs of photonic polarization states may include, for example, the rectilinear, diagonal, and circular photonic polarization states. The rectilinear basis may refer to the pair of rectilinear photonic polarization states including the horizontal photon polarization state |0> and the vertical photon polarization state |1>. The diagonal basis may refer to the pair of diagonal and anti-diagonal photonic polarization states at 45 and 135 degrees, respectively. The circular basis may refer to the pair of circular photonic polarization states include the left circular photon polarization state |L> and the right circular photon polarization state |R>. The terms “state” or “states” may refer to a basic unit of quantum information comprising a two-level quantum mechanical system, such as the polarization of a single photon (e.g., a photon encoded using a quantum basis as described above).

Although described herein with reference to qubits transmitted via a quantum communication channel, the present disclosure contemplates that the techniques described herein may be applicable to quantum particles of any type. Furthermore, the basis (e.g., quantum state) of the qubit(s) transmitted by the first quantum transmitter 1304 may be only one such example of a first quantum characteristic of the qubits transmitted by the first quantum transmitter 1304. By way of a non-limiting example, the frequency, wavelength, and/or any other quantum characteristic, property, attribute, etc. of the qubits generated and transmitted by the first quantum transmitter 1304 may be varied based upon the intended application of the first communication module 1302. As described more fully hereinafter, the first quantum characteristics associated with the qubit(s) generated and transmitted by the first communication module 1302 may be at least partially impacted by the quantum characteristics associated with other qubits transmitted within the same communication medium (e.g., quantum communication channel via an optical fiber or free space). Still further, the first quantum characteristics associated with the qubit(s) generated and transmitted by the first communication module 1302 may be, in some embodiments, at least partially impacted or controlled by the equipment capabilities associated with the first quantum transmitter 1304.

The first communication module 1302 may further include a first quantum receiver 1306 configured to receive (e.g., measure) qubits. As described hereafter, the first quantum receiver 1306 may be configured to measure qubits that are received, via the first communication medium 1308, from the second communication module 1307 (e.g., generated by a second quantum transmitter 1309). By way of continued example, the qubit serves as the object in quantum communication within which data is encoded, and the quantum basis of the qubit refers to a way in which data is encoded. As such, the first quantum receiver 1306 may be configured to measure qubits having second quantum characteristics, such as a quantum basis state used to encode data, the frequency of the qubits, the wavelength of the qubits, and/or the like. As described hereafter, at least one of the second quantum characteristics may be different from at least one of the first quantum characteristics so that qubits having the first quantum characteristics (e.g., transmitted by the first quantum transmitter 1304) and qubits having the second quantum characteristics (e.g., measured by the first quantum receiver 1306) may exist in the same first communication medium 1308. In other words, the second quantum characteristics, as defined by the second quantum transmitter 1309 described hereafter, may be such that bi-directional communication via the first communication medium 1308 may be achieved between the first communication module 1302 and the second communication module 1307. By way of a non-limiting example, time binning techniques, radio frequency (RF) modulation techniques, phase locking to shifted LOs (in the case of continuous variables), measurement using different basis, and/or any measurable physical attribute that may distinguish between an upstream channel and a downstream channel in the bi-directional communication implementations described herein may be used.

The second communication module 1307 may include a second quantum transmitter 1309 configured to generate qubits (e.g., photons or the like). The data of the qubits may be encoded via sets of orthogonal quantum states, including, but not limited to, pairs of photonic polarization states. The pairs of photonic polarization states may include, for example, the rectilinear, diagonal, and circular photonic polarization states as defined above. The second quantum characteristics associated with the qubit generated by the second quantum transmitter 1309 may include the basis of the qubit(s) transmitted by the second quantum transmitter 1309. Although described herein with reference to basis, the present disclosure contemplates that the second quantum characteristics may include the frequency, wavelength, and/or any other quantum characteristic, property, attribute, etc. of the qubits generated and transmitted by the second quantum transmitter 1309 and that the second quantum characteristics may be varied based upon the intended application of the second communication module 1307.

The second communication module 1307 may further include a second quantum receiver 1311 configured to receive (e.g., measure) qubits. Similar to the first quantum receiver 1306, the second quantum receiver 1311 may be configured to measure qubits that are received, via the first communication medium 1308, from the first communication module 1302 (e.g., generated by the first quantum transmitter 1304). The second quantum receiver 1311 may be configured to measure qubits having first quantum characteristics, such as the quantum basis used to encode data, the frequency of the qubits, the wavelength of the qubits, and/or the like.

The first communication medium 1308, as shown in FIG. 13, is further configured to communicably couple the first communication module 1302 and the second communication module 1307 such that communication is provided between the first quantum transmitter 1304 and the second quantum receiver 1311 and between the second quantum transmitter 1309 and the first quantum receiver 1306 via the first communication medium 1308. The first communication medium 1308 may refer to an optical line, fiber, a quantum line, and/or free space over which quantum data or information and particles, such as qubits, are exchanged. These would include quantum communication channels used for applying one or more quantum cryptographic techniques (e.g., QKD) that rely on quantum properties, such as quantum uncertainty, superposition, and/or quantum entanglement. Although the first communication medium 1308 is described herein with reference to a quantum communication channel, the present disclosure contemplates that the techniques described herein may be applicable to any communication channel. Furthermore, although described herein with reference to example embodiments in which the communication channel refers to an optical fiber or free space, the present disclosure contemplates that a communication channel may refer to any mechanism, structure (e.g., or absence thereof), or the like through which quantum information-based communications (e.g., photons, qubits, single or entangled quantum particles, etc.) may propagate or otherwise travel.

In some embodiments, the first communication medium 1308 may include an optical fiber such that communication between the first quantum transmitter 1304 and the second quantum receiver 1311 and communication between the second quantum transmitter 1309 and the first quantum receiver 1306 is provided by the same optical fiber. In other words, a common communication medium is used for bi-directional quantum communication between the first communication module 1302 and the second communication module 1307. In such an embodiment, a transmission of qubits between the first quantum transmitter 1304 and the second quantum receiver 1311 and a transmission of qubits between the second quantum transmitter 1309 and the first quantum receiver 1306 may occur at the same or substantially the same time. Although described herein with reference to an optical fiber implementation, the present disclosure contemplates that the bi-directional quantum communication techniques described herein may also be applicable to instances in which the first communication medium 1308 comprises a free space communication medium.

In an example bi-directional quantum communication operation, the first quantum transmitter 1304 may receive instructions (e.g., from the GPU/CPU 1305 and/or network card described hereafter) to generate and transmit qubits having first quantum characteristics (e.g., basis, frequency, wavelength, etc.). Similarly, the second quantum transmitter 1309 may receive instructions (e.g., from another GPU/CPU or another computing device) to generate and transmit qubits having second quantum characteristics (e.g., basis, frequency, wavelength, etc.), one of which is different from the first quantum characteristics. The qubits may be transmitted from the first quantum transmitter 1304 and the second quantum transmitter 1309 to the second quantum receiver 1311 and the first quantum receiver 1306, respectively, via the same optical fiber (e.g., first communication medium 1308). The second quantum receiver 1311 may measure the qubits having the first quantum characteristics to receive the data encoded thereon. The first quantum receiver 1306 may similarly measure the qubits having the second quantum characteristics to receive the data encoded thereon. The present disclosure contemplates that the bi-directional quantum interconnect 1300 may leverage any computing device, GPU/CPU 1305, or the like communicably coupled thereto in order to, in whole or in part, control operation of the first communication module 1302 and the second communication module 1307. Furthermore, in some embodiments, the first quantum transmitter 1304 and/or the second quantum transmitter 1309 may each configured to generated entangled pairs of qubits.

With continued reference to FIG. 13, in some embodiments, the bi-directional quantum interconnect 1300 may employ classical communication channels, such as via optical transceivers. By way of a non-limiting example, the first communication module 1302 may include a first optical transceiver 1301 that is configured to generate optical signals (e.g., via a vertical cavity surface emitting laser (VCSEL) or the like) and receive optical signals (e.g., via a photodiode (PD) or the like). The second communication module 1307 may include a second optical transceiver 1303 that may similarly be configured to generate optical signals (e.g., via a vertical cavity surface emitting laser (VCSEL) or the like) and receive optical signals (e.g., via a photodiode (PD) or the like). These optical signals may also be transmitted via the first communication medium 1308 (e.g., an optical fiber or the like) and be used to, for example, facilitate synchronization between the first communication module 1302 and the second communication module 1307. Although described herein with reference to example synchronization operations, the present disclosure contemplates that a classical communication channel, such as the paired first optical transceiver 1301 and the second optical transceiver 1303, may be used for any operation (e.g., transmission of data between parties, sifting operations, etc.) based upon the intended application of the bi-directional quantum interconnect 1300.

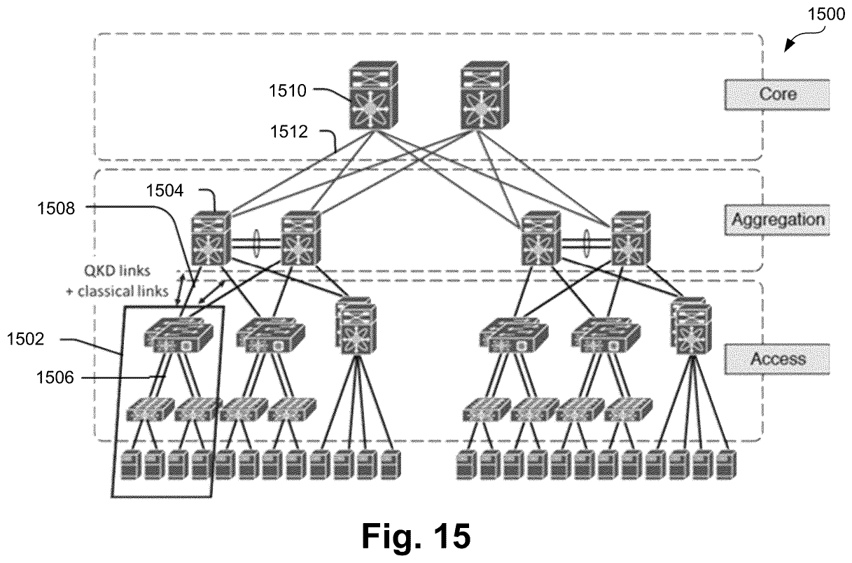

FIG. 14 illustrates a system 1400 that facilitates QKD connectivity between more than two HPC systems according to one or more embodiments of the present disclosure. According to various embodiments, the system 1400 provides a crossbar optical switch to facilitate different connections among HPC systems. In an embodiment illustrated in FIG. 14, the system 1400 includes an HPC system 1402, an HPC system 1404, an HPC system 1406, and/or an HPC system 1408. The system 1400 also includes an optical switch 1410. The optical switch 1410 can be, for example, a crossbar optical switch that includes switches arranged in a matrix configuration to facilitate connections among the HPC system 1402, the HPC system 1404, the HPC system 1406 and/or the HPC system 1408. For example, the optical switch 1410 can include multiple input communication channels and multiple output communication channels that form a crossed pattern of interconnections to facilitate connections among the HPC system 1402, the HPC system 1404, the HPC system 1406, and/or the HPC system 1408.

The HPC system 1402 can be communicatively coupled to the HPC system 1404, the HPC system 1406, and/or the HPC system 1408 via the optical switch 1410. For example, the HPC system 1402 can be communicatively coupled to the optical switch 1410 via a QKD link 1412. Furthermore, the optical switch 1410 can be communicatively coupled to the HPC system 1404 via a QKD link 1414. As such, the HPC system 1402 can be communicatively coupled to the HPC system 1404 via the QKD link 1412, the optical switch 1410, and the QKD link 1414. In another example, the HPC system 1402 can be communicatively coupled to the optical switch 1410 via the QKD link 1412. Furthermore, the optical switch 1410 can be communicatively coupled to the HPC system 1406 via a QKD link 1416. As such, the HPC system 1402 additionally or alternatively can be communicatively coupled to the HPC system 1406 via the QKD link 1412, the optical switch 1410 and the QKD link 1416. In yet another example, the HPC system 1402 can be communicatively coupled to the optical switch 1410 via the QKD link 1412. Furthermore, the optical switch 1410 can be communicatively coupled to the HPC system 1408 via a QKD link 1418. As such, the HPC system 1402 additionally or alternatively can be communicatively coupled to the HPC system 1408 via the QKD link 1412, the optical switch 1410 and the QKD link 1418.

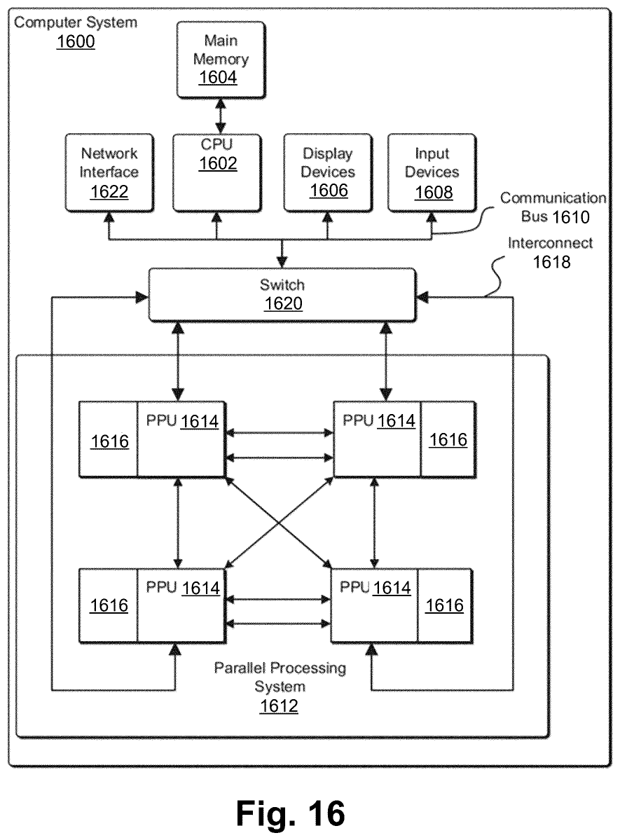

FIG. 15 illustrates a system 1500 that facilitates QKD communication via a fat-tree datacenter architecture according to one or more embodiments of the present disclosure. According to various embodiments, the system 1500 provides classical links within a computer cluster and QKD links external to the computer cluster. For instance, the system 1500 includes a computer cluster 1502. The computer cluster 1502 includes, for example, a set of connected computers (e.g., a set of connected processor cores, a set of connected servers, and/or a set of connected routers) associated with classical links 1506. Furthermore, the computer cluster 1502 is communicatively coupled to a server 1504 via a QKD link 1508. In certain embodiments, the computer cluster 1502 can be associated with an access layer of a datacenter network and the server 1504 can be associated with an aggregation layer of the datacenter network. In one or more embodiments, the server 1504 can be additionally communicatively coupled to a server 1510 via a classical link 1512. In certain embodiments, the server 1510 can be associated with a core layer of the datacenter network.

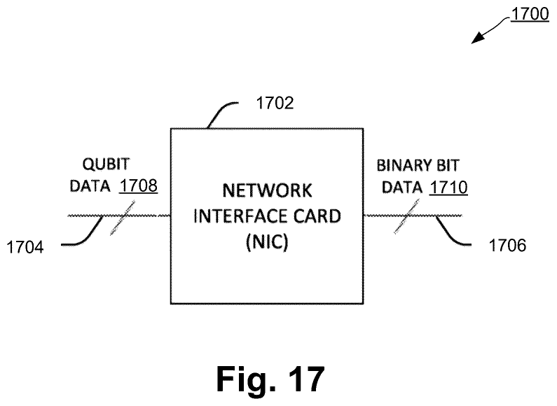

FIG. 16 illustrates a computer system 1600, according to at least one embodiment. In at least one embodiment, computer system 1600 is configured to implement various processes and methods described throughout this disclosure. In at least one embodiment, computer system 1600 comprises, without limitation, at least one central processing unit (“CPU”) 1602 that is connected to a communication bus 1610 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1600 includes, without limitation, a main memory 1604 and control logic (e.g., implemented as hardware, software, or a combination thereof) and data are stored in main memory 1604 which may take form of random access memory (“RAM”). In at least one embodiment, a network interface subsystem (“network interface”) 1622 provides an interface to other computing devices and networks for receiving data from and transmitting data to other systems from computer system 1600.

In at least one embodiment, computer system 1600, in at least one embodiment, includes, without limitation, input devices 1608, parallel processing system 1612, and display devices 1606 which can be implemented using a conventional cathode ray tube (“CRT”), liquid crystal display (“LCD”), light emitting diode (“LED”), plasma display, or other suitable display technologies. In at least one embodiment, user input is received from input devices 1608 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 1604 and/or secondary storage. Computer programs, if executed by one or more processors, enable system 1600 to perform various functions in accordance with at least one embodiment. memory 1604, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 1602; parallel processing system 1612; an integrated circuit capable of at least a portion of capabilities of both CPU 1602; parallel processing system 1612; a chipset (e.g., a group of integrated circuits designed to work and sold as a unit for performing related functions, etc.); and any suitable combination of integrated circuit(s).

In at least one embodiment, parallel processing system 1612 includes, without limitation, a plurality of parallel processing units (“PPUs”) 1614 and associated memories 1616. In at least one embodiment, PPUs 1614 are connected to a host processor or other peripheral devices via an interconnect 1618 and a switch 1620 or multiplexer. In at least one embodiment, parallel processing system 1612 distributes computational tasks across PPUs 1614 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 1614, although such shared memory may incur performance penalties relative to use of local memory and registers resident to a PPU 1614. In at least one embodiment, operation of PPUs 1614 is synchronized through use of a command such as_syncthreads( ) wherein all threads in a block (e.g., executed across multiple PPUs 1614) to reach a certain point of execution of code before proceeding.

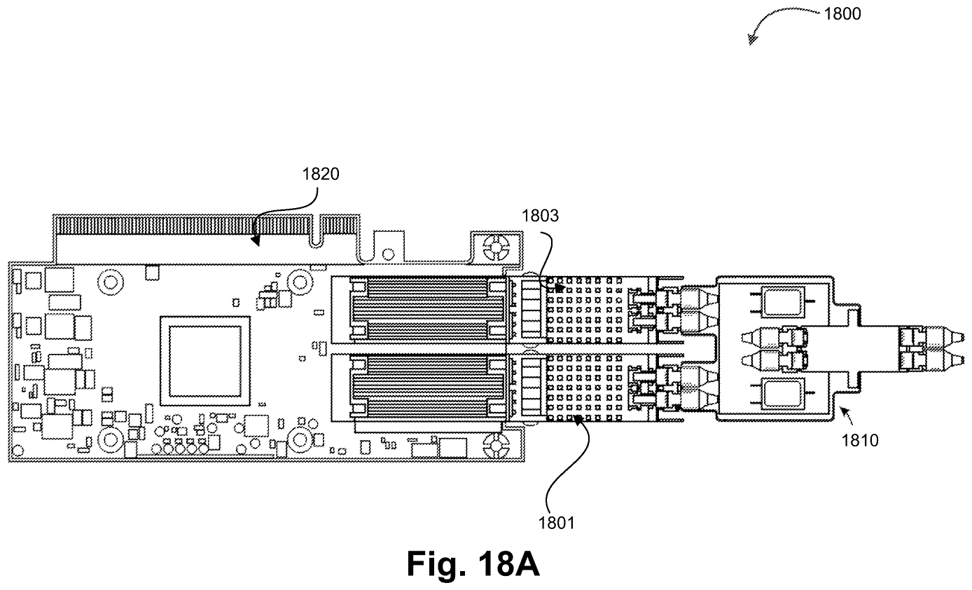

FIG. 17 illustrates a system 1700 according to one or more embodiments of the present disclosure. The system 1700 includes a network interface controller (NIC) 1702. The NIC 1702 is, for example, a hardware component (e.g., a network interface controller) configured to connect to a network and/or to facilitate communications within the network. In certain embodiments, the NIC 1702 can be included in and/or can be coupled to a network interface module such as a transceiver device (e.g., an optical transceiver) that facilitates fiber optic communication. In one or more embodiments, the NIC 1702 can be configured to manage transmission of one or more optical signals via an optical fiber. Additionally or alternatively, in one or more embodiments, the NIC 1702 can be configured to control emission of one or more optical signals via a laser.

The NIC 1702, as depicted in FIG. 17, is coupled to a communication channel 1704 and a communication channel 1706. The communication channel 1704 may be a first communication channel associated with quantum communication (e.g., a QKD-based communication). The communication channel 1706 may be a second communication channel associated with classical network communication (e.g., non-QKD-based communication). In one or more embodiments, the communication channel 1706 is an optical communication channel (e.g., a transparent fiber optical connection) that transmits data (e.g., pulses of infrared light) encoded via qubits (e.g., a quantum communication data stream). In one or more embodiments, the communication channel 1706 is an optical communication channel (e.g., a transparent fiber optical connection) that transmits data (e.g., pulses of infrared light) encoded via bits (e.g., a binary data stream). Accordingly, the NIC 1702 can be configured to interface a QKD-based communication medium and a non-QKD-based communication medium. In an embodiment, the NIC 1702 is configured to receive qubit data 1708 via the communication channel 1704. The qubit data 1708 can include, for example, qubits associated with quantum information. Furthermore, in an embodiment, the NIC 1702 is configured to output binary bit data 1710 via the communication channel 1706. The binary bit data 1710 can include, for example, one or more classical binary bits associated with binary information. In one or more embodiments, the communication channel 1704 and/or the communication channel 1706 can be bi-directional. As such, in another embodiment, the NIC 1702 is configured to output the qubit data 1708 via the communication channel 1704. Furthermore, in another embodiment, the NIC 1702 is configured to receive the binary bit data 1710 via the communication channel 1706.

### Transceiver Module

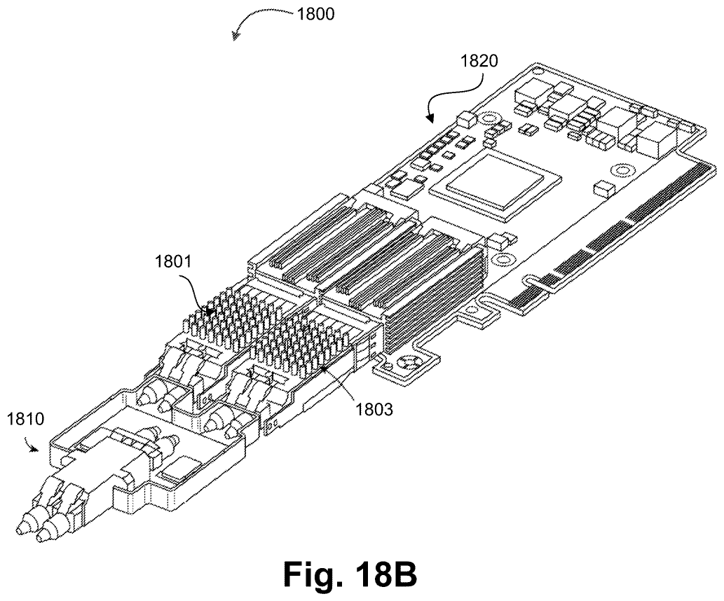

FIGS. 18A and 18B illustrate a top view and a perspective view, respectively, of a transceiver module operatively coupled to a network adapter, in the present example transceiver module 1800, in accordance with an embodiment of the disclosure. As shown in FIGS. 18A and 18B, the transceiver module may include a first optical module 1801, a second optical module 1803, an adapter 1810, and a dual-port NIC 1820 of a server. Both the first optical module 1801 and the second optical module 1803 may be dual-fiber transceivers that are configured for duplex communication that allows the source (e.g., server) to communicate with the target (e.g., leaf switch) in both directions. The adapter 1810 may be a ganged physical component configured to link the first optical module 1801 and the second optical module 1803 for the purpose of transmitting and receiving data to and from the leaf switch.

In some embodiments, the adapter 1810 may be configured to operate in two configurations, such as a first configuration and a second configuration. In one aspect, the first configuration may be a default configuration of operation, where the first optical module 1801 may be operationally active. The second configuration may be a contingent configuration that is implemented when the first optical module 1801 operationally fails. When such a failure is detected, the second optical module 1803, which is otherwise operationally inactive or idle, may be engaged become operationally active and handle all network traffic that was initially handled by the first optical module 1801.

In some embodiments, the transceiver module 1800 may be configured to operate in a leaf-spine architecture. A leaf-spine architecture is a data center network topology that may include two switching layers—a spine layer and a leaf layer. The leaf layer may include access switches (leaf switches) that aggregate traffic from servers and connect directly into the spine or network core. Spine switches interconnect all leaf switches in a full-mesh topology between access switches in the leaf layer and the servers from which the access switches aggregate traffic. As such, in one embodiment, to ensure reliable operation of downlinks, the transceiver module 1800 may be configured to operate between the server and the leaf layer. In particular, as shown in FIGS. 18A and 18B, the adapter 1810 may be operatively coupled to the first optical module 1801 and the second optical module 1803, while the first optical module 1801 and the second optical module 1803 may be operatively coupled to a dual-port NIC 1820 of a server.

In embodiments, the transceiver module 1800 may comprise one or more processing circuits, as detailed above; the processing circuits may comprise FW, that is loaded according to the techniques described above.

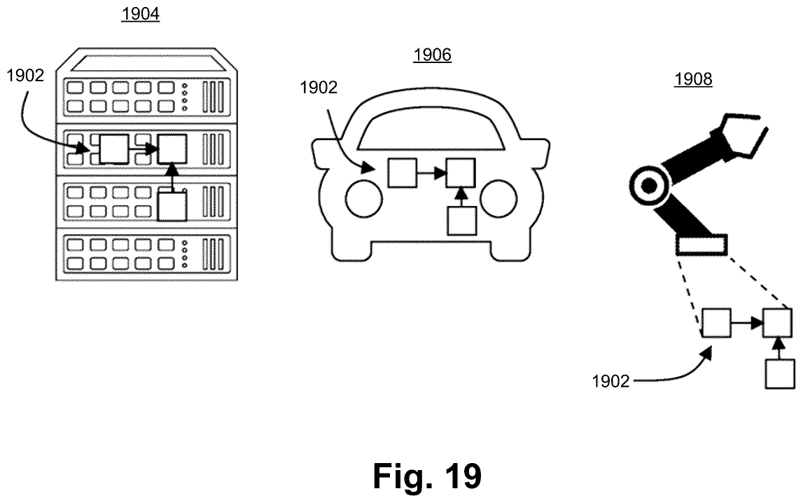

FIG. 19 depicts exemplary scenarios for use of an optical transceiver 1902 in accordance with some embodiments. An optical transceiver 1902 may be utilized in a computing system 1904 (e.g., in a server farm, or within a server computer system), a vehicle 1906 (e.g., a car, truck, train, or airplane), and a robot 1908 (or among robots in a factory), to name just a few examples. The optical transceiver 1902 may be particularly useful for high-speed communication in environments subject to high levels of electromagnetic interference (EMI).

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light.

In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally comprise a smaller diameter than the optical fibers. As such, a “world-to-chip” interface problem often arises in SiP technologies where coupling of light between Si wire waveguides and optical fibers, and vice versa, is generally inefficient.

Traditionally, for fiber-to-chip coupling, a fiber coupling technique using spot-size converters (SSCs) or grating couplers is employed. However, grating couplers for fiber-to-chip coupling typically provide a narrow bandwidth and/or an undesirable polarization sensitivity for certain optical applications. Furthermore, SSCs and grating couplers for fiber-to-chip coupling are generally attached to the chip through an adhesive bonding technique that results in a silicon communication chip with bundles of fibers attached thereto, resulting in increased complexity for handling and/or assembly of the chips onto other optical systems. Additionally, wafers for traditional SiP devices are generally diced (e.g., fully cut through) to create an edge for the wafer to expose waveguide facets and/or to facilitate butt attachment of the SiP device to an external device.

### Optical Switch

High-capacity optical switch assemblies switch multiple channels of data at high data rates, with the number of channels reaching several hundreds and data rates reaching hundreds of Gb/s (Gb/s=10⁹ bits per second). In order to save power, it is desirable to co-package the switch itself with “optical engines,” which typically are small, high-density optical transceivers located within an application-specific integrated circuit (ASIC) or within an ASIC package together with the switch.

The switch assembly is contained in a rack-mounted case, with optical receptacles on its front panel for ease of access. The signals from and to the ASIC are conveyed to and from the optical receptacles using optical fibers.

To further simplify installation and use, it is sometimes desirable that the optical cable be detachable from the transceivers so that a smaller cable may be routed through an installation. Each optical cable may, instead of comprising a transceiver, be designed to mate with a particular transceiver. The transceiver may be connected to a node, such as a server, and be used to connect a connector of each cable to the node as described herein.

In embodiments, the optical switch assembly may comprise one or more processing circuits; the processing circuits may comprise firmware that is loaded according to the techniques described above.

Optical switches are one solution for enabling advances in networking due to the technology's potential for very high data capacity and low power consumption. Optical switches feature optical input and output ports and are capable of routing light that is coupled to the input ports to the intended output ports on demand, according to one or more control signals (electrical or optical control signals). Routing of the signals is performed in the optical domain, i.e. without the need for optical-electrical and electrical-optical conversion, thus bypassing the need for power-consuming transceivers. Header processing and buffering of the data is not possible in the optical domain and thus, packet switching (as it is realized in electrical switches) cannot be employed. Instead, the circuit switching paradigm is used: an end-to-end circuit is created for the communication between two endpoints connected on the input and the output of the optical switch. Director switches may be used in the most common datacenter interconnection topologies, e.g., fat trees, Slim Fly, and Dragonfly+). In addition, inventive concepts propose to place such hybrid switching systems “in the middle” of the network (e.g., replacing the edge/top of rack (TOR) layer and aggregation layer).

An optical switch may include hardware and/or software for routing signals in the optical domain. Thus, in one embodiment, an optical switch may include input optical fibers and output optical fibers that carry optical signals as well as one or more devices suited for routing optical signals within the optical switch. For example, the one or more devices for routing optical signals may include one or more movable mirrors (e.g., MEMS mirrors) that are controlled to move in a manner that directs light from an input fiber to a desired output fiber or to move in a manner that forces or guides light from one waveguide into another waveguide. An optical switch may include one or more devices for amplifying light in order to compensate for propagation and scattering losses introduced by the optical switch. In at least one example embodiment, signals input and output to an ASIC are optical, meaning that each optical switch connected to an electrical switch routes optical signals received from the electrical switch without using hardware and/or software that converts an electrical signal into an optical signal for routing within the optical switch. However, example embodiments are not limited thereto, and an optical switch may include electrical to optical to electrical conversion hardware and/or software if desired (e.g., if the input signal and/or output signal is an electrical signal).

The optical switch(es) may include an arrayed waveguide grating router (AWGR), which is a passive switch fabric. In some embodiments, the optical switch(es) may correspond to a passive element that operates as a wavelength router that uses multiple wavelengths to interconnect outputs and inputs by following a specific cyclic wavelength routing pattern.

An optical switch, on the other hand, may function by directly routing optical signals without converting them to electrical signals. Each optical switch may include optical receivers, such as photodetectors and wavelength-division multiplexing (WDM) demultiplexers, that receive incoming optical signals. These optical signals may then be directed through internal optical switching components, such as micro-electromechanical systems (MEMS) mirrors, waveguides, or optical cross-connects, which route the signals to the appropriate output paths. The optical switch may also include optical transmitters, such as laser diodes and modulators, which transmit the routed optical signals to the next switch in the network. A hybrid electro-optical switch may combine both electrical and optical components to route signals. Such a switch may include receivers that convert optical signals into electrical signals using TIAs and photodetectors, similar to those in electrical switches. These electrical signals can then be routed within the switch using internal electrical switching circuitry. Additionally, the hybrid switch may contain optical switching components, such as WDM multiplexers and MEMS devices, to route optical signals directly. The transmitters in a hybrid switch may include both electrical-to-optical converters and direct optical transmitters, enabling the hybrid switch to interface with both electrical and optical networks. For example, a hybrid switch's transmitter may include a light source, a modulator for optical signals, and traditional electrical signal transmitters, providing routing capabilities across different signal domains.

The interconnections between the switches within the network topology may be implemented via optical fibers or traditional electrical cables, depending on the specific requirements of the system. For instance, the communication lanes may be constructed of dedicated differential cable pairs and/or fiber optics, each tailored to provide optimal performance for the data transmission needs. The dedicated differential cable pairs used in these interconnections may include a variety of cable media such as copper, aluminum, gold, silver, nickel, or composite materials like copper-clad aluminum, copper-clad steel, or bimetallic conductors. These materials may be chosen for their electrical conductivity and durability, ensuring reliable and efficient data transmission. For example, in a four-lane network, each lane may consist of its own dedicated copper cable, providing isolated physical paths for each communication lane of a deserialized data stream. This configuration helps in maintaining signal integrity and reducing crosstalk between lanes.

Alternatively, fiber optic cables may be employed for the interconnections. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. Various optical networking technologies can be used to transmit multiple optical signals (e.g., data signals or data streams) over a single optical fiber within an optical link with little to no optical signal interference. These technologies may be used to improve bandwidth efficiency and reduce the amount of infrastructure needed for data communication.

One such technology is Time Division Multiplexing (TDM). In TDM, multiple optical signals can be transmitted over a single optical fiber by assigning each optical signal a respective time slot and transmitting an optical signal during its assigned time slot. The time slots are allocated in a cyclic manner, with each optical signal transmitting a small amount of data during its assigned time slot. The time slots are very short, on the order of microseconds, and the cycle repeats many times per second, allowing for rapid data transfer.

Another technology is Frequency Division Multiplexing (FDM). In FDM, multiple optical signals can be transmitted over a single optical fiber by assigning each optical signal a respective frequency band. Each optical signal is modulated onto a respective carrier frequency to generate a modulated signal, and these modulated signals are combined and transmitted over a single optical fiber. At the receiver, the modulated signals are separated using filters (e.g., band-pass filters) that permit optical signals meeting specific frequency specifications to pass through while filtering out other signals. FDM allows optical links to simultaneously transmit multiple channels over the same frequency band.

Yet another technology is Wavelength Division Multiplexing (WDM). In WDM, multiple optical signals having different wavelengths are combined into a single optical signal and transmitted over a single optical fiber. WDM techniques involve combining and separating multiple optical signals with different wavelengths onto a single optical fiber, allowing for more data to be transmitted and increasing the capacity of the optical fiber.

Examples of WDM technology include Coarse Wavelength Division Multiplexing (CWDM) and Dense Wavelength Division Multiplexing (DWDM). CWDM combines multiple optical signals at different wavelengths into a single optical signal and transmits it over a single optical fiber. CWDM uses a wider wavelength separation, such as about 80 nanometers (nm), which means it supports fewer channels and has lower power budgets, making it suitable for shorter distances, up to about 80 kilometers (km). CWDM requires less complex equipment and lower-cost optical components, making it a cost-effective solution for applications that do not require dense wavelength separation. In contrast, DWDM uses narrower wavelength separation, such as about 0.8 nm, allowing for higher channel capacity and longer distances, but typically at a higher cost and complexity.

### Optical Switch Assemblies

High-capacity optical switch assemblies switch multiple channels of data at high data rates, with the number of channels reaching several hundreds and data rates reaching hundreds of Gb/s (Gb/s=109 bits per second). In order to save power, it is desirable to co-package the switch itself with “optical engines,” which typically are small, high-density optical transceivers located within an application-specific integrated circuit (ASIC) or within an ASIC package together with the switch.

The switch assembly is contained in a rack-mounted case, with optical receptacles on its front panel for ease of access. The signals from and to the ASIC are conveyed to and from the optical receptacles using optical fibers.

Space constraints of the switch and the front panel limit the number of optical fibers connected to the ASIC and optical receptacles on the panel. Therefore, the optical signals emitted and received by the switch are multiplexed using wavelength-division multiplexing, so that each fiber, along with the associated optical receptacle, carries multiple optical signals. For example, each fiber may carry four channels of 100 Gb/s each, at four different, respective wavelengths, to and from the corresponding optical receptacle, for a total data rate of 400 Gb/s (denoted as 4×100 Gb/s).

In many cases, the multiple communication channels carried at different wavelengths on the same fiber are directed to and from different network nodes. For example, each of the 100 Gb/s component signals on a 4×100 Gb/s optical link may be directed to a different server. Therefore, there is a need for an optical cable that is capable of splitting the multiplexed optical signal into multiple component signals at different, respective wavelengths, and be capable of conveying each of these signals to a different network node. For simplicity of installation and use, it is desirable that the optical cable be “active,” meaning that transceivers in the cable convert each of the multiple optical signals to a standard electrical form (and vice versa). As a result, the network nodes need process only electrical signals and will be indifferent to the actual wavelength of the optical channel that is directed to each of them.

To further simplify installation and use, it is sometimes desirable that the optical cable be detachable from the transceivers so that a smaller cable may be routed through an installation. Each optical cable may, instead of comprising a transceiver, be designed to mate with a particular transceiver. The transceiver may be connected to a node, such as a server, and be used to connect a connector of each cable to the node as described herein.

### Example System Use-Cases

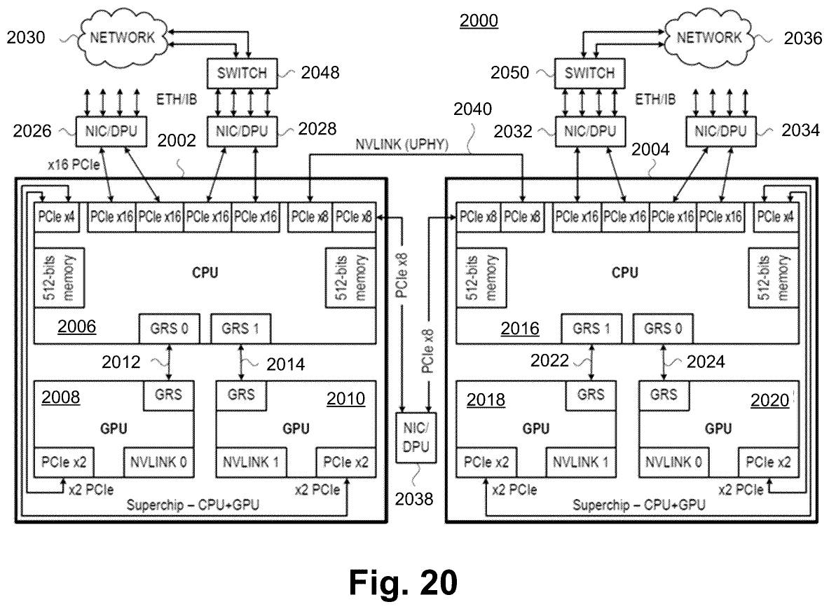

FIG. 20 is a block diagram that schematically illustrates a computing system 2000, e.g., a data center or a High-Performance Computing (HPC) cluster, in accordance with an embodiment that is described herein. System 2000 comprises a plurality of subsystems, e.g. multiple processing devices coupled to each other, multiple network devices, and multiple networks, according to at least one embodiment. Computing system 2000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 2000 and to one or more external networks 2030, 2036. In the present example, system 2000 comprises a packet switch 2048 that connects NIC/DPU 2028 to network 2030, and a packet switch 2050 that connects NIC/DPU 2032 to network 2036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 2000 can include one or more CPUs and one or more GPUs.

FIG. 20 also demonstrates an example architecture of a multi-GPU architecture. As illustrated in the figure, computing system 2000 includes a processing device 2002 with a multi-GPU architecture. In particular, processing device 2002 may be a system-on-chip and includes multiple subsystems such as a CPU 2006, a GPU 2008, and a GPU 2010. CPU 2006 can be coupled to GPU 2008 via a die-to-die (D2D) or chip-to-chip (C2C) interconnect 2012, such as a Ground-Referenced Signaling interconnect (GRS interconnect). CPU 2006 can be coupled to GPU 2010 via a D2D or C2C interconnect 2014. CPU 2006 can also couple to GPU 2008 and GPU 2010 via PCIe interconnects.

CPU 2006 can be coupled to one or more NICs or DPUs, which are coupled to one or more networks. For example, as illustrated in FIG. 20, CPU 2006 is coupled to a first NIC/DPU 2026, which is coupled to a network 2030. CPU 2006 is also coupled to a second NIC/DPU 2028, which is coupled to network 2030 via switch 2048. NIC/DPU 2026 and NIC/DPU 2028 can be coupled to network 2030 over Ethernet (ETH), NVLINK or InfiniBand (IB) connections, for example.

Computing system 2000 also includes a processing device 2004 with a multi-GPU architecture. In particular, processing device 2004 includes multiple subsystems including a CPU 2016, a GPU 2018, and a GPU 2020. CPU 2016 can be coupled to GPU 2018 via an D2D or C2C interconnect 2022. CPU 2016 can be coupled to GPU 2020 via a D2D or C2C interconnect 2024. CPU 2016 can also couple to GPU 2018 and GPU 2020 via PCIe interconnects. CPU 2016 can be coupled to one or more NICs or DPUs, which are coupled to one or more networks. For example, as illustrated in FIG. 20, CPU 2016 is coupled to a first NIC/DPU 2032, which is coupled to a network 2036. CPU 2016 is also coupled to a second NIC/DPU 2034, which is coupled to network 2036 via switch 2050. NIC/DPU 2032 and NIC/DPU 2034 can be coupled to network 2036 over Ethernet (ETH), NVLINK or InfiniBand (IB) connections.

In at least one embodiment, processing device 2002 and processing device 2004 can communication with each other via a NIC/DPU 2038, such as over PCIe interconnects. Processing device 2002 and processing device 2004 can also communicate with each other over a high-bandwidth communication interconnects 2040, such as an NVLink interconnect or other high-speed interconnects. The packet switches in FIG. 20 may comprise, for example, Nvidia Quantum-2 switches. The NICs/DPUs in the figure may comprise, for example, Nvidia Bluefield DPUs.

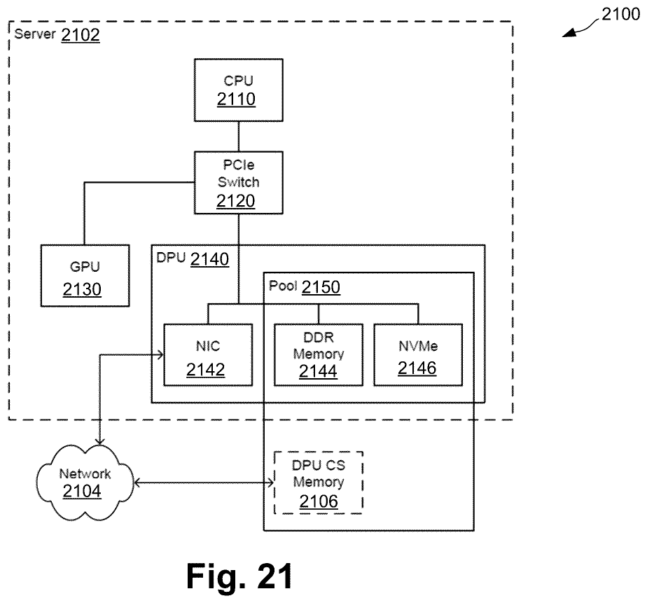

FIG. 21 illustrates an example computing environment, in accordance with at least one embodiment. FIG. 21 illustrates an example computing environment 2100 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 2100 may include a server 2102 which may be used to perform HPC workloads, such as AI training or machine learning model training. In an embodiment, the server 2102 may be an application instance or a compute node. The server 2102 may include a CPU 2110 associated with a switch 2120, such as a peripheral component interconnect express (PCIe) switch, which may control at least some data transmission over communication paths interconnecting various components. In an embodiment, the CPU 2110 may include a root complex processor.

The PCIe switch 2120 may also be associated with a GPU 2130 and a DPU 2140 and may transmit data between at least some of the CPU 2110, the GPU 2130, the DPU 2140, and other components. In an embodiment, the PCIe switch 2120 may be associated with more than one GPU or more than one DPU. In another embodiment, the PCIe switch 2120 may be located within the DPU 2140. The PCIe switch 2120 may manage the transfer of at least some data between the CPU 2110, the GPU 2130, and the DPU 2140. In another embodiment, the number of GPUs associated with the PCIe switch 2120 may be equal to the number of DPUs associated with the PCIe switch 2120. In at least one embodiment, the server 2102 may include, without limitation, any number of the CPUs 2110, the PCIe switches 2120, the GPUs 2130, and/or the DPUs 2140, in any combination. For example, in at least one embodiment, server 2102 could include eight, sixteen, thirty-two, and/or more GPUs 2130. In at least one embodiment, communication paths interconnecting various components, including but not limited to the CPU 2110, the PCIe switch 2120, the GPU 2130, and the DPU 2140, in FIG. 21 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 2140 may include a network interface controller (NIC) 2142, a DDR memory 2144, and a non-volatile memory express (NVMe) device 2146. The NIC 2142 may be able to interface with a network 2104, which may also interface with additional NVMe devices available to the DPU 2140, such as over fabric. In an embodiment, the DPU 2140 may not include the NVMe device 2146. In another embodiment, the NVMe device 2146 may be located on the server 2102 and not on the DPU 2140. In yet another embodiment, the computing environment 2100 may include more than one of the NVMe device 2146, such as a first NVMe device in the DPU 2140 and a second first NVMe device on the server 2102 an associated directly with the PCIe switch 2120. In an embodiment, the DPU 2140 may not include the DDR memory 2144 and may include a computational storage service (CSS) in place of, or in addition to, the DDR memory 2144. For example, computing environment 2100 may include DPU computational storage (CS) memory 2106 available to the DPU 2140 as part of the CSS. The network 2104 may be able to interface with the DPU CS memory 2106 through the NIC 2142, according to any suitable interface protocol, such as remote direct memory access (RDMA) over Ethernet, InfiniBand, Fiber Channel, etc.

The total memory of the computing environment 2100 available for data storage may be expanded through the use of the DPU 2140 on nodes of the system. The DPU 2140 may have access to a pool 2150 of memory already available to the server 2102, such as double data rate (DDR) memory, on-board NVMe devices, NVMe devices over fabric, and CS. The pool 2150 of memory may include at least one of the DDR memory 2144, NVMe 2146, and the DPU CS memory 2106. The DPU 2140 may also be able to access the available memory of other DPUs as part of the pool 2150, and other DPUs may be able to access the available memory of DPU 2140, such as the pool 2150. This available memory can be accessed and utilized for data storage, without the addition of compute resources, such as compute nodes, which would be required using other solutions. The available pool 2150 accessible to the DPU 2140 may be provisioned for the server 2102 to expand the total memory available for data storage, such as to reduce the data storage load on the CPU 2110 or the GPU 2130, which can instead increase the utilization of their memory for processing. For example, during training of an AI, the model states, residual states, activation functions, and checkpoints can be stored, or offloaded, on the pool 2150 accessible to the DPU 2140.

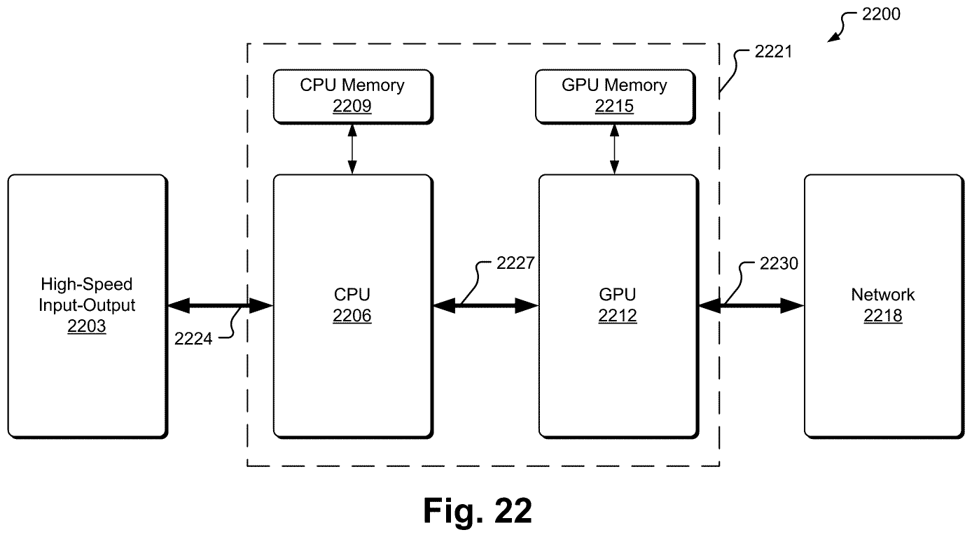

FIG. 22 is a block diagram that schematically illustrates a computing system 2200, e.g., a data center or a High-Performance Computing (HPC) cluster, in accordance with an embodiment that is described herein, including at least a first processing device 2221. The computing system 2200 also includes a network 2218 which may include a network of GPUs, such as an NVLink network including up to 256 GPUs.

The processing device 2221 may include a CPU 2206, a GPU 2212, CPU memory 2209, and GPU memory 2215. The CPU 2206 and the GPU 2212 of the processing device 2221 may communicate via one or more interconnects 2227 such as an NVLink or other highspeed interconnect. The CPU memory 2209 may be low-power double data rate (LPDDR) 5× memory or another memory type. The GPU memory 2215 may be high bandwidth memory (HBM), HBM3, or HBM3e memory, or another memory type.

The processing device 2221 may be in communication with a high-speed input-output (IO) 2203 via one or more PCIe or other high-speed interconnects 2224. In one example, the CPU 2206 of the processing device 2221 is connected to the high-speed IO 2203 via four 16× PCIe-5 connections. In at least one embodiment, the high-speed IO 2203 is a NIC/DPU and enables connection with the processing device 2221, such as over PCIe interconnects 2224.

The network 2218 may include a number of processing devices and may be coupled to the processing device 2221 via one or more interconnects 2230. In an example, the processing device 2221 is connected to the network 2281 via eighteen NVLink 4 interconnects 2230. The coupling of processing devices through NVLink allows for seamless data exchange and parallel processing, enhancing overall computational performance. The processing devices are connected to multiple networks through one or more NICs or DPUs, enabling the system to handle complex, multi-network tasks with high bandwidth and low latency. This configuration is highly suitable for demanding applications that require significant processing power, such as AI, ML, and data-intensive computing, while ensuring robust connectivity and scalability across various networked environments. The integrated circuits of the computing system 2200 can include one or more CPUs and one or more GPUs.

In some implementations, threads of a GPU 2212 of a first processing device 2221 may be enabled to access GPU memory 2215 and/or CPU memory 2209 of one or more peer processing devices 2221 in the network 2218, such as via an NVLink page table. As an example, CUDA APIs may allow applications to map memory from remote nodes into a current process and then perform load, stores, atomics, and/or bulk memory transfers to directly access the memory. Communication between the processing device 2221 and devices in the network 2218 may be implemented using one or more of the QKD transceivers as described above.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably, and include any appropriate type of methodology, process, operation, or technique.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

Use of terms “a,” “an,” “the,” and similar referents in context of describing disclosed embodiments (as well as in the context of the following claims) are to be construed to cover both singular and plural, unless otherwise indicated herein or clearly contradicted by context, and not as a definition of a term. The term “and/or” is to be construed as including any and all combinations of one or more of the associated listed items. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into the specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in an illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Embodiments of the present disclosure include an apparatus, the apparatus including: a quantum key distribution (QKD) transmitter circuit, the QKD transmitter circuit including: a modulator configured to encode one or more photons according to respective quantum states; and an attenuator configured to enable the encoded one or more photons to transmit via an optical communication channel.

Aspects of the above embodiment include wherein the QKD transmitter circuit is configured to polarize one or more photons according to respective quantum states.

Aspects of the above embodiment include wherein the apparatus is one of a mid-board optical module (MBOM), a linear pluggable optics (LPO) transceiver, a quad small form-factor pluggable (QSFP) transceiver, a quad small form-factor pluggable double density (QSFP-DD) transceiver.

Aspects of the above embodiment include wherein the apparatus includes a bi-directional transceiver.

Aspects of the above embodiment include wherein the QKD transmitter circuit is further to transmit a data signal via the optical communication channel.

Aspects of the above embodiment include wherein the QKD transmitter circuit receives power from a device connected to the apparatus.

Aspects of the above embodiment include wherein the apparatus further includes a QKD receiver circuit to detect a second one or more photons received by the apparatus and to process a signal from the second one or more photons.

Aspects of the above embodiment include wherein the apparatus further includes a QKD receiver circuit to detect a transmission comprised of a second one or more photons per symbol.

Aspects of the above embodiment include wherein the apparatus further includes a pluggable body, wherein the QKD transmitter circuit is within the pluggable body.

Aspects of the above embodiment include wherein the apparatus further includes: a data transmitter circuit; a quantum receiver circuit; and a data receiver circuit.

Aspects of the above embodiment include wherein the apparatus further includes a hybrid QKD-data transmitter circuit including: the QKD transmitter circuit; a data transmitter circuit configured to output a data signal; and a multiplexer configured to multiplex the one or more photons from the QKD transmitter circuit with the data signal from the data transmitter circuit and to output a multiplexed signal via the optical communication channel.

Aspects of the above embodiment include wherein the apparatus further includes a hybrid QKD-data receiver circuit including: a second QKD circuit configured to detect one or more qubits received by the apparatus via a second optical communication channel; a data receiver circuit configured to receive a second data signal via the second optical communication channel; and a demultiplexer configured to demultiplex the one or more qubits and the second data signal from a multiplexed optical signal received by the apparatus via the second optical communication channel.

Aspects of the above embodiment include wherein the apparatus is an optical switch.

Aspects of the above embodiment include wherein the QKD transmitter circuit and the quantum transmitter circuit are contained within a co-packaged optics (CPO) package.

Aspects of the above embodiment include wherein the apparatus further includes optical and electronic components integrated in a microchip.

Aspects of the above embodiment include wherein the optical communication channel includes a dedicated fiber link.

Aspects of the above embodiment include wherein the optical communication channel connects two nodes within a data center.

Aspects of the above embodiment include wherein the apparatus is equivalent in size to a small form-factor pluggable module.

Aspects of the above embodiment include wherein the optical communication channel connects devices in different data centers, on different floors of a data center, or on different racks of a floor of a data center.

Embodiments include a transceiver, the transceiver including: a quantum key distribution (QKD) transmitter circuit, the QKD transmitter circuit including: a modulator configured to encode one or more photons according to respective quantum states; and an attenuator configured to enable the encoded one or more photons to transmit via an optical communication channel.

Aspects of the above embodiment include wherein the QKD transmitter circuit is configured to polarize one or more photons according to respective quantum states.

Aspects of the above embodiment include wherein the transceiver is one of a mid-board optical module (MBOM), a linear pluggable optics (LPO) transceiver, a quad small form-factor pluggable (QSFP) transceiver, a quad small form-factor pluggable double density (QSFP-DD) transceiver.

Aspects of the above embodiment include wherein the transceiver includes a bi-directional transceiver.

Aspects of the above embodiment include wherein the QKD transmitter circuit is further to transmit a data signal via the optical communication channel.

Aspects of the above embodiment include wherein the QKD transmitter circuit receives power from a device connected to the apparatus.

Aspects of the above embodiment include wherein the transceiver further includes a QKD receiver circuit to detect a second one or more photons received by the apparatus and to process a signal from the second one or more photons.

Aspects of the above embodiment include wherein the transceiver further includes a pluggable body, wherein the QKD transmitter circuit is within the pluggable body.

Aspects of the above embodiment include wherein the transceiver further includes: a data transmitter circuit; a quantum receiver circuit; and a data receiver circuit.

Aspects of the above embodiment include wherein the transceiver further includes a hybrid QKD-data transmitter circuit including: the QKD transmitter circuit; a data transmitter circuit configured to output a data signal; and a multiplexer configured to multiplex the one or more photons from the QKD transmitter circuit with the data signal from the data transmitter circuit and to output a multiplexed signal via the optical communication channel.

Embodiments include a quantum key distribution (QKD) device, the QKD device including: a quantum key distribution (QKD) transmitter circuit, the QKD transmitter circuit including: a modulator configured to encode one or more photons according to respective quantum states; and an attenuator configured to enable the encoded one or more photons to transmit via an optical communication channel.

Embodiments include a data center, the data center including: a plurality of nodes; an optical communication channel providing data communication between the plurality of nodes; and a transceiver, including: a quantum key distribution (QKD) transmitter circuit, the QKD transmitter circuit including: a modulator configured to encode one or more photons according to respective quantum states; and an attenuator configured to enable the encoded one or more photons to transmit via an optical communication channel.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or the like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example implementations of described techniques, other architectures may be used to implement described functionality and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. An apparatus, comprising:
a quantum key distribution (QKD) transmitter circuit, the QKD transmitter circuit comprising:
a modulator configured to encode one or more photons according to respective quantum states; and
an attenuator configured to enable the encoded one or more photons to transmit via an optical communication channel.

2. The apparatus of claim 1, wherein the QKD transmitter circuit is configured to polarize one or more photons according to respective quantum states.

3. The apparatus of claim 1, wherein the apparatus is one of a mid-board optical module (MBOM), a linear pluggable optics (LPO) transceiver, a quad small form-factor pluggable (QSFP) transceiver, a quad small form-factor pluggable double density (QSFP-DD) transceiver.

4. The apparatus of claim 1, wherein the apparatus comprises a bi-directional transceiver.

5. The apparatus of claim 1, wherein the QKD transmitter circuit is further to transmit a data signal via the optical communication channel.

6. The apparatus of claim 1, wherein the QKD transmitter circuit receives power from a device connected to the apparatus.

7. The apparatus of claim 1, further comprising a QKD receiver circuit to detect a second one or more photons received by the apparatus and to process a signal from the second one or more photons.

8. The apparatus of claim 1, further comprising a QKD receiver circuit to detect a transmission comprised of a second one or more photons per symbol.

9. The apparatus of claim 1, further comprising a pluggable body, wherein the QKD transmitter circuit is within the pluggable body.

10. The apparatus of claim 1, further comprising:
a data transmitter circuit;
a quantum receiver circuit; and
a data receiver circuit.

11. The apparatus of claim 1, further comprising a hybrid QKD-data transmitter circuit comprising:
the QKD transmitter circuit;
a data transmitter circuit configured to output a data signal; and
a multiplexer configured to multiplex the one or more photons from the QKD transmitter circuit with the data signal from the data transmitter circuit and to output a multiplexed signal via the optical communication channel.

12. The apparatus of claim 11, further comprising a hybrid QKD-data receiver circuit comprising:
a second QKD circuit configured to detect one or more qubits received by the apparatus via a second optical communication channel;
a data receiver circuit configured to receive a second data signal via the second optical communication channel; and
a demultiplexer configured to demultiplex the one or more qubits and the second data signal from a multiplexed optical signal received by the apparatus via the second optical communication channel.

13. The apparatus of claim 1, wherein the apparatus is an optical switch.

14. The apparatus of claim 1, wherein the QKD transmitter circuit and the quantum transmitter circuit are contained within a co-packaged optics (CPO) package.

15. The apparatus of claim 1, wherein the apparatus further comprises optical and electronic components integrated in a microchip.

16. The apparatus of claim 1, wherein the optical communication channel comprises a dedicated fiber link.

17. The apparatus of claim 1, wherein the optical communication channel connects two nodes within a data center.

18. The apparatus of claim 1, wherein the apparatus is equivalent in size to a small form-factor pluggable module.

19. A transceiver, comprising:
a quantum key distribution (QKD) transmitter circuit, the QKD transmitter circuit comprising:
a modulator configured to encode one or more photons according to respective quantum states; and
an attenuator configured to enable the encoded one or more photons to transmit via an optical communication channel.

20. A quantum key distribution (QKD) device, comprising:
a quantum key distribution (QKD) transmitter circuit, the QKD transmitter circuit comprising:
a modulator configured to encode one or more photons according to respective quantum states; and
an attenuator configured to enable the encoded one or more photons to transmit via an optical communication channel.
